(19) United States
(12) Patent Application Publication
(10) Pub. No.: US 2024/0318023 A1
(43) Pub. Date: Sep. 26, 2024

(54) Ink Jet Ink Composition, Recording Method, And Set

(71) Applicant: SEIKO EPSON CORPORATION, Tokyo (JP)

(72) Inventors: Akinobu SUMIYOSHI, Shiojiri (JP); Kenta UCHIDA, Matsumoto (JP); Yusuke MIZUTAKI, Shiojiri (JP)

(21) Appl. No.: 18/613,343

(22) Filed: Mar. 22, 2024

(30) Foreign Application Priority Data
Mar. 23, 2023 (JP) 2023-046811

(51) Int. Cl. C09D 11/38; B41J 2/175; C09D 11/107; C09D 11/324

(52) U.S. Cl. CPC C09D 11/38; B41J 2/17509; B41J 2/17553; B41J 2/17566; C09D 11/107; C09D 11/324; B41J 2002/17573

(57) ABSTRACT

Provided is an aqueous ink jet ink composition including a self-dispersing pigment, a water-soluble resin, and a betaine, in which the ink jet ink composition is used by an ink jet recording device that includes an ink storage container having an ink filling hole, a content of the self-dispersing pigment is 3.5% by mass or greater and 8.5% by mass or less with respect to a total mass of the ink composition, a mass ratio (self-dispersing pigment/water-soluble resin) of the self-dispersing pigment to the water-soluble resin is 2.8 or greater and less than 30, and a content of the betaine is 2.5% by mass or greater and 9.5% by mass or less with respect to the total mass of the ink composition.

The present application is based on, and claims priority from JP Application Serial Number 2023-046811, filed Mar. 23, 2023, the disclosure of which is hereby incorporated by reference herein in its entirety.

### BACKGROUND

### 1. Technical Field

The present disclosure relates to an ink jet ink composition, a recording method, and a set.

### 2. Related Art

Ink jet recording has been performed in a wide range of fields. The ink jet recording is actively employed for household use and business use. Further, an ink jet printer provided with a large ink storage container has been attracting attention in terms that such a printer requires less effort to replace an ink cartridge and easily carries out continuously printing.

For example, JP-A-2015-061896 discloses an ink composition containing a pigment, a resin, and an organic solvent, in which the ink composition is poured into an ink container including an ink chamber configured to replenish the ink composition and an ink filling hole configured to be opened and closed, in which the ink chamber is configured to communicate with outside air.

A continuous supply type ink container as described in JP-A-2015-061896 is a so-called atmosphere open type container formed such that an ink chamber can be opened to the atmosphere. When an ink is poured into such a container, there are concerns of formation of air bubbles, generation of foreign matter from ink components at a gas-liquid interface of an ink-liquid surface, and the like.

Such generation of air bubbles or foreign matter in the ink causes clogging. For example, this tendency is significant when the ink contains resin particles. Meanwhile, the ink is required to have excellent rub resistance after adhering to a recording medium. Further, the ink is required to have excellent color developability.

### SUMMARY

According to an aspect of the present disclosure, there is provided an aqueous ink jet ink composition including: a self-dispersing pigment; a water-soluble resin; and a betaine, in which the ink jet ink composition is used for an ink jet recording device that includes an ink storage container having an ink filling hole, a content of the self-dispersing pigment is 3.5% by mass or greater and 8.5% by mass or less with respect to a total mass of the ink composition, a mass ratio (self-dispersing pigment/water-soluble resin) of the self-dispersing pigment to the water-soluble resin is 2.8 or greater and less than 30, and a content of the betaine is 2.5% by mass or greater and 9.5% by mass or less with respect to the total mass of the ink composition.

According to another aspect of the present disclosure, there is provided a recording method performed by using an ink jet recording device that includes an ink storage container having an ink filling hole, the method including: jetting an ink jet ink composition from an ink jet head of the ink jet recording device to make the ink jet ink composition adhere to a recording medium, in which the ink jet ink composition is the ink jet ink composition described above.

According to still another aspect of the present disclosure, there is provided a set including: an ink jet recording device that includes an ink storage container having an ink filling hole; and an ink jet ink composition that is used for performing recording by the ink jet recording device, in which the ink jet ink composition is the ink jet ink composition described above.

### BRIEF DESCRIPTION OF THE DRAWINGS

FIG. 1 is a perspective view schematically showing a schematic configuration of a recording device in a see-through state according to a first embodiment.

FIG. 2 is a perspective view showing an ink supply unit provided inside a housing of the recording device.

FIG. 3 is a plan view showing the ink supply unit.

FIG. 4 is a partially broken cross-sectional view taken along line IV-IV in FIG. 3.

FIG. 5 is a perspective view showing an ink storage container in a state where a cap is removed.

FIG. 6 is a partially broken front view showing the ink storage container in a state of performing an operation of replenishing an ink to the ink storage container.

FIG. 7 is a table (Table 1) listing the formulation and the like of compositions of examples.

FIG. 8 is a table (Table 2) listing the formulation and the like of compositions of examples.

FIG. 9 is a table (Table 3) listing the formulation and the like of compositions of comparative examples.

FIG. 10 is a table (Table 4) listing the formulation and the like of compositions of comparative examples.

FIG. 11 is a table (Table 5) listing the evaluation results of compositions of examples.

FIG. 12 is a table (Table 6) listing the evaluation results of compositions of examples.

FIG. 13 is a table (Table 7) listing the evaluation results of compositions of comparative examples.

FIG. 14 is a table (Table 8) listing the evaluation results of compositions of comparative examples.

### DESCRIPTION OF EMBODIMENTS

Hereinafter, embodiments of the present disclosure will be described. The embodiments described below are examples of the present disclosure. The present disclosure is not limited to the following embodiments and also includes various modifications implemented within a range not departing from the scope of the present disclosure. Further, not all configurations described below are essential configurations of the present disclosure.

### 1. Ink Jet Ink Composition

An ink jet ink composition of the present embodiment is an aqueous composition containing a self-dispersing pigment, a water-soluble resin, and a betaine. Further, the ink jet ink composition is used for an ink jet recording device that includes an ink storage container having an ink filling hole.

### 1.1. Self-Dispersing Pigment

The ink jet ink composition according to the present embodiment contains a self-dispersing pigment. The self-dispersing pigment is a pigment that can be dispersed and/or dissolved in an aqueous medium without a dispersant such as a resin or a surfactant. Here, the expression of “dispersed and/or dissolved in an aqueous medium without a dispersant” denotes a state where the pigment is stably present in an aqueous medium due to a hydrophilic group on the surface thereof even when a dispersant for dispersing the pigment is not used.

Since the ink jet ink composition containing a self-dispersing pigment is not required to contain a dispersant for dispersing a pigment, formation of air bubbles and degradation of defoaming properties caused by a dispersant are unlikely to occur, and thus the jetting stability is likely to be improved. Further, generation of foreign matter at a gas-liquid interface caused by a dispersant when the ink jet ink composition is dried is suppressed, and thus the jetting reliability is also excellent. Further, since a significant increase in viscosity caused by a dispersant is suppressed, the ink jet ink composition can be allowed to contain a larger amount of pigment, and as a result, the print density can be further increased.

Further, when a recording medium contains calcium, an image with excellent color developability is likely to be formed due to the reaction between the self-dispersing pigment and the calcium. Such color developability is likely to be obtained when a self-dispersing pigment having a surface to which a phosphorus-containing group such as a phosphoric acid group or a phosphonic acid group, a carboxy group, a sulfo group, or the like is bonded is used. This tendency is strong particularly in a case of a self-dispersing pigment having a surface to which a phosphorus-containing group is bonded, which is preferable. Among the examples, a phosphoric acid group is particularly preferable.

The self-dispersing pigment tends to have slightly inferior fixing properties of an image compared to a pigment formed such that an anionic resin is physically adsorbed on the surfaces of pigment particles or a resin dispersing pigment dispersed in a state where an anionic resin contains a pigment, but the ink jet ink composition according to the present embodiment can exhibit excellent fixing properties of an image by using a water-soluble resin described below.

A pigment obtained by bonding a hydrophilic group to the surface of the pigment directly or via other atomic groups is used as the self-dispersing pigment, and examples thereof include a pigment obtained by bonding a functional group containing an anionic group to the surfaces of the pigment particles and a pigment obtained by chemically bonding an anionic resin to the surface of the pigment particles.

Examples of the hydrophilic group present on the surface of the self-dispersing pigment include —OM, —COOM, —CO—, —SO₃M, —SO₂M, —SO₂NH₂, —RSO₂M, —PO₃HM, —PO₃M₂, —SO₂NHCOR, —NH₃, —NR₃, and a group in which some hydrogen atoms of a propyleneoxy chain have been substituted with M. In the formulae, M represents a hydrogen atom, an alkali metal, ammonium, or an organic amine, and R represents an alkyl group having 1 or more and 12 or less carbon atoms or a naphthyl group which may have a substituent.

Further, examples of the other atomic groups include a linear or branched alkyl group having 1 or more and 12 or less carbon atoms, a phenylene group, a naphthylene group, an amide group, a sulfonyl group, an amino group, a carbonyl group, an ester group, an ether group, and a group obtained by combining these groups.

A pigment in which an anionic group is bonded to the surfaces of the pigment particles by performing an oxidation treatment using a known method and a pigment in which a functional group containing an anionic group is bonded to the surfaces of the pigment particles by performing diazo coupling may be employed as the above-described self-dispersing pigments, and both pigments can be suitably used. The self-dispersing pigment obtained by bonding an anionic resin to the surfaces of the pigment particles is a pigment in which a resin having a unit containing at least an anionic group as a hydrophilic unit is bonded to the surfaces of the pigment particles directly or via other atomic groups.

The pigment of a self-dispersion type is not particularly limited, and examples of the kind of pigment include an inorganic pigment such as carbon black, calcium carbonate, or titanium oxide, and an organic pigment such as an azo pigment, an isoindolinone pigment, a diketopyrrolopyrrole pigment, a phthalocyanine pigment, a quinacridone pigment, or an anthraquinone pigment.

Examples of a black pigment include No. 2300, No. 900, MCF88, No. 33, No. 40, No. 45, No. 52, MA7, MA8, MA100, and No. 2200B (all manufactured by Mitsubishi Chemical Corporation), Raven 5750, Raven 5250, Raven 5000, Raven 3500, Raven 1255, and Raven 700 (all manufactured by Columbia Carbon Co., Ltd.), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all manufactured by Cabot Corporation), and Color Black FW1, Color Black FW2, Color Black FW2V, Color Black FW18, Color Black FW200, Color black S150, Color Black S160, Color Black S170, Printex 35, Printex U, Printex V, Printex 140U, Special Black 6, Special Black 5, Special Black 4A, and Special Black 4 (all manufactured by Degussa-Huls AG).

Examples of a white pigment include C.I. Pigment White 1 (basic lead carbonate), 4 (zinc oxide), 5 (mixture of zinc sulfide and barium sulfate), 6 (titanium oxide), 6:1 (titanium oxide containing other metal oxides), 7 (zinc sulfide), 18 (calcium carbonate), 19 (clay), 20 (titanium mica), 21 (barium sulfate), 22 (natural barium sulfate), 23 (gloss white), 24 (alumina white), 25 (gypsum), 26 (magnesium oxide/silicon oxide), 27 (silica), and 28 (anhydrous calcium silicate).

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

Examples of pigments of colors other than black, white, yellow, magenta, and cyan include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Further, examples of color pigments include phthalocyanine-based pigments, azo-based pigments, anthraquinone-based pigments, azomethine-based pigments, and fused ring-based pigments in addition to Pigment yellow Series, Pigment Red Series, Pigment Violet Series, and Pigment Blue Series listed in the color index. Further, other examples thereof include organic pigments such as Yellow No. 4, No. 5, No. 205, and No. 401, Orange No. 228 and No. 405, and Blue No. 1 and No. 404, and inorganic pigments such as titanium oxide, zinc oxide, zirconium oxide, iron oxide, ultramarine, Prussian blue, and chromium oxide.

The above-described pigments can be defined as the pigments obtained by bonding an anionic group to the surfaces of the particles directly or via other atomic groups.

For example, when carbon black is used as the self-dispersing pigment, the self-dispersing pigment is produced by, for example, performing a physical treatment or a chemical treatment on carbon black so that a hydrophilic group is bonded (grafted) to the surface of carbon black. Examples of such a physical treatment include a vacuum plasma treatment. Further, examples of the chemical treatment include an oxidation treatment using hypohalous acid and/or a hypohalite, an oxidation treatment using ozone, and an oxidation treatment using persulfuric acid and/or a persulfate.

Further, a commercially available product may be used as carbon black used as the self-dispersing pigment, and examples thereof include CAB-O-JET (registered trademark) 300 (manufactured by Cabot Specialty Chemicals Inc.).

In addition, examples of pigments other than carbon black used as the self-dispersing pigment include a pigment obtained by bonding a hydrophilic group to the surface of the pigment via a phenyl group. Various known surface treatment methods can be applied as a surface treatment method of bonding the above-described functional group as a hydrophilic group or a salt thereof to the surface of the pigment via a phenyl group, and examples of such a surface treatment include a method of bonding a hydrophilic group to the surface of the pigment via a phenyl group by bonding sulfanilic acid, p-aminobenzoic acid, 4-aminosalicylic acid, or the like to the surface of the pigment.

A commercially available product can also be used as such a color pigment used as the self-dispersing pigment, and examples thereof include CAB-O-JET (registered trademark) 250C, CAB-O-JET (registered trademark) 260M, and CAB-O-JET (registered trademark) 470Y (all manufactured by Cabot Specialty Chemicals Inc.).

The content of the self-dispersing pigment (solid content) is 3.5% by mass or greater and 8.5% by mass or less with respect to the total mass of the ink jet ink composition. Further, the content of the self-dispersing pigment (solid content) is preferably 4% by mass or greater and more preferably 4.5% by mass or greater with respect to the total mass of the ink jet ink composition. Further, the content of the self-dispersing pigment (solid content) is preferably 8% by mass or less, more preferably 7.5% by mass or less, and particularly preferably 7% by mass or less with respect to the total mass of the ink jet ink composition. When the content of the self-dispersing pigment is in the above-described ranges, the color developability and clogging recovering properties may be improved.

In the ink jet ink composition according to the present embodiment, the amount of the water-soluble resin and the amount of the self-dispersing pigment to be blended are set such that the mass ratio (self-dispersing pigment/water-soluble resin) of the self-dispersing pigment to the water-soluble resin is set to 2.8 or greater and less than 30. Further, such a mass ratio is preferably 3.0 or greater and less than 28 and more preferably 3.2 or greater and less than 25.

The rub resistance of an image is degraded when the amount of the water-soluble resin is small with respect to the amount of the self-dispersing pigment, and the clogging resistance may be degraded when the amount of the water-soluble resin is large with respect to the amount of the self-dispersing pigment.

### 1.2. Water-Soluble Resin

The ink jet ink composition according to the present embodiment contains a water-soluble resin. The water-soluble resin mainly contributes to the fixing properties of an image. Further, the water-soluble resin exhibits a small surface active action, and thus formation of air bubbles when the ink storage container is filled with the ink jet ink composition from the filling hole is suppressed.

The water-soluble resin is different from resin particles and thus unlikely to be formed into foreign matter at the gas-liquid interface. However, when the water-soluble resin is dried at the gas-liquid interface, clogging resistance may be degraded due to the components that have been dried and solidified. Since the water-soluble resin is highly hydrophilic, the water-soluble resin is formed into foreign matter and unlikely to be redissolved in some cases when water is dried and the environment is hydrophobic. It is assumed that particularly the water-soluble resin and the self-dispersing pigment subjected to a hydrophilic treatment are formed into composite foreign matter and unlikely to be redissolved when water is dried and the environment is hydrophobic.

When the ink jet ink composition according to the present embodiment contains a betaine described below, a state in which the water-soluble resin is incorporated in (absorbed by) the betaine is considered to be formed, and as a result, it is assumed that formation of foreign matter from the water-soluble resin is suppressed and resolubility can be obtained even in a case where the water-soluble resin is formed into foreign matter. In this manner, the clogging resistance is considered to be enhanced.

Further, foreign matter mixed with other components such as the self-dispersing pigment is formed from the water-soluble resin in the ink jet in composition in some cases, but when the ink jet ink composition according to the present embodiment contains a betaine described below, a state in which the water-soluble resin is incorporated in (absorbed by) the betaine is considered to be formed, and as a result, it is assumed that formation of foreign matter from the water-soluble resin is suppressed and resolubility can be obtained even in a case where the water-soluble resin is formed into foreign matter. In this manner, the clogging resistance is considered to be enhanced.

Further, the water-soluble resin can also increase the fastness of an image. The mechanism of the water-soluble resin in increasing the fastness of an image is different from the mechanism of dispersion particles in improving the fastness of an image. The water-soluble resin is considered to have an action of fixing an image to a recording medium through a reaction with calcium (Ca) contained in a recoding medium. Meanwhile, the main mechanism of the resin particles is fixation of the resin using moisture evaporation, and the fixation of the resin takes a relatively long time. Therefore, a significant difference in the fastness is not observed after a certain amount of time has passed from the printing, but the water-soluble resin can exhibit excellent fastness earlier in a case of comparison immediately after the printing. Since the water-soluble resin quickly fixes ink components onto a recording medium through the reaction with Ca of the recording medium, the color developability is also more excellent.

In the present specification, the water-soluble resin is different from a resin for dispersing a pigment (pigment dispersion resin) used for dispersing a pigment and denotes a resin dissolved in an ink without adhering to a pigment by adsorption or the like. Further, in the present specification, the term “water-soluble” denotes a property that 3% by mass or greater of the resin can be dissolved in ion exchange water at 20° C. The amount of resin to be dissolved is preferably 5% by mass or greater, more preferably 10% by mass, and still more preferably 25% by mass or greater. The expression of “can be dissolved” denotes that undissolved residues, turbidity, and layer separation are not observed after water and the resin is mixed and stirred. Further, the water-soluble resin is a resin dissolved in water without indicating a resin dispersion (resin particles) in which the resin is dispersed in water.

The water-soluble resin can be classified into an anionic resin, a nonionic resin, a cationic resin, and the like in terms of the characteristics. In the ink jet ink composition according to the present embodiment, it is preferable to use an anionic resin. That is, it is preferable that the water-soluble resin contain an acidic group in the structure and have an acid value. The acidic group may be in the form of a salt. Examples of the acidic group include a carboxy group, a sulfonyl group, and a phosphoric acid group. Among these, a carboxy group is more preferable.

The acid value of the water-soluble resin is preferably 200 [KOHmg/g] or greater and 700 [KOHmg/g] or less, more preferably 250 [KOHmg/g] or greater and 600 [KOHmg/g] or less, and still more preferably 350 [KOHmg/g] or greater and 450 [KOHmg/g] or less. When the acid value of the water-soluble resin is in the above-described ranges, since the balance between the hydrophobic group and the hydrophilic group is satisfactory, an image with satisfactory water resistance while the solubility of the water-soluble resin in water is excellent can be obtained.

Meanwhile, when the acid value of the water-soluble resin is less than the above-described ranges, foreign matter is likely to be formed due to a decrease in the solubility of the water-soluble resin in water. Further, when the acid value of the water-soluble resin is greater than the above-described ranges, the water resistance of an image may be degraded due to an extreme increase in the solubility of the water-soluble resin in water. Further, the term “acid value” denotes the amount of KOH (mg) required to neutralize 1 g of the water-soluble resin. The acid value is measured by titration. For example, the acid value can be measured by a method (potentiometric titration method) in conformity with JIS K 0070:1992.

Preferred examples of the water-soluble resin include an acrylic resin, a maleic acid-based resin, a urethane-based resin, and a polyester-based resin.

The acrylic resin is a resin polymerized using at least an acrylic monomer. The maleic acid-based resin is a resin polymerized using at least maleic acid or a maleic acid derivative. More specific examples thereof include an acrylic resin, a styrene-acrylic resin, a styrene-maleic acid-based resin, an acrylonitrile-acrylic resin, and a vinyl acetate-acrylic resin. Further, it is preferable that the water-soluble resin be selected from an acrylic resin or a maleic acid-based resin.

Further, a maleic acid-based resin polymerized using at least maleic acid or a maleic acid derivative, such as a styrene-maleic acid-based resin, is more preferable. That is, the maleic acid-based resin is a polymer compound having a structure derived from maleic acids.

Further, a resin polymerized using at least an acrylic monomer and maleic acid or a maleic acid derivative is defined as the maleic acid-based resin.

Examples of the maleic acids include a compound having a structure in which one carboxyl group is bonded to each of adjacent carbon atoms bonded to each other via a carbon-carbon double bond of ethylene and a compound that is a derivative thereof.

Specific examples of the maleic acids include maleic acid, maleic anhydride, fumaric acid, citraconic acid, citraconic anhydride, and mesaconic acid. The maleic acids may be compounds obtained by cyclodehydrating or esterifying the carboxyl groups respectively bonded to the adjacent carbon atoms. The carboxyl groups include a carboxyl group that forms a salt.

Examples of the derivatives include a derivative in which a carboxyl group is derived as described above and a derivative in which an ethylene skeleton further has a substituent.

Among the maleic acids, a derivative in which maleic acid is derived and a derivative in which a carboxyl group of the maleic acid is derived are preferably used.

A carboxyl group derived from maleic acids may be cyclodehydrated or esterified as the maleic acid-based resin. The carboxyl group also includes a salt formed by a carboxyl group.

The polymer compound having a structure derived from maleic acids can be a polymer compound obtained by performing polymerization or copolymerization using at least maleic acids.

The maleic acid-based resin may be a polymer of maleic acids or a copolymer of maleic acids and other monomers. Examples of other monomers include vinyl monomers such as styrene, vinylnaphthalene, and vinyl acetate, and acrylic monomers such as (meth)acrylic acid and esters of (meth)acrylic acid.

The maleic acid-based resin has a structure derived from maleic acids, and adjacent carbon atoms have a carboxyl group or a structure derived from a carboxyl group. Here, for example, a polymer of acrylic acid is polymerized in a so-called head-tail manner when the polymer is polymerized by a commonly known method, and thus it is statistically rare for carboxyl groups to be disposed in adjacent carbon atoms. Therefore, when polymerization of a polymer of acrylic acids is compared with polymerization of maleic acids, it is rare for carboxyl groups to be disposed adjacent to each other in a carbon chain of the main chain in a polymer. In this manner, it is possible to confirm whether adjacent carboxyl groups are derived from maleic acids by a nuclear magnetic resonance (NTMR) method.

The carboxyl group of the maleic acid-based resin may be esterified. For example, the carboxyl group may be esterified by a compound containing a hydroxyl group. Two carboxyl groups having a structure derived from maleic acids may not be esterified, and one or two carboxyl groups may be esterified.

Further, when the carboxyl group having a structure derived from maleic acids is not esterified, the carboxyl group may be present as a carboxylic acid in an aqueous ink jet ink composition or may be partially or completely neutralized by ammonia, alkanolamine, or alkylamine.

The maleic acid-based resin is soluble in water due to having many structures derived from the carboxyl group of maleic acids. Therefore, the molecular chain of the maleic acid-based resin expands in the aqueous ink jet ink composition. In this manner, when the ink jet ink composition is mixed with an aggregating agent, the probability that the maleic acid-based resin comes in contact with the aggregating agent increases. Accordingly, the maleic acid-based resin has satisfactory aggregating properties, and thus the image quality of an image obtained by using the ink set can be increased.

The water resistance of an image to be obtained is likely to be improved when one carboxyl group between two carboxyl groups of the structures derived from maleic acids of the maleic acid-based resin is esterified. Further, the water resistance of an image to be obtained is likely to be degraded when two carboxyl groups of the structures derived from maleic acids are not esterified. The balance between the hydrophilicity and the hydrophobicity of the maleic acid-based resin can be adjusted by the degree of esterification. In this manner, the storage stability of the ink jet ink composition can be further enhanced, and the water resistance of an image to be obtained can be further improved. For example, a styrene maleic anhydride half ester copolymer salt is preferable in terms of the balance between the hydrophilicity and the hydrophobicity. The reason for this is assumed to be that the esterified carboxyl group has high hydrophobicity, and thus insolubilization and solid-liquid separation during the reaction are promoted.

Further, when the maleic acid-based resin has structures derived from maleic anhydride, the anhydride is considered to be a carboxyl group in water due to addition of water.

Further, the maleic acid-based resin is a water-soluble resin, and a resin which is different from a pigment dispersant and is present as a solution dissolved in water serving as a solvent component of the ink without being adsorbed on a pigment in the ink jet ink composition is used as the maleic acid-based resin. The maleic acid-based resin described in this section is contained in the ink separately from a pigment dispersant when the ink contains a pigment dispersed by a pigment dispersant.

The maleic acid-based resin exhibits aggregating properties due to the action of an aggregating agent such as calcium propionate described below depending on the number and the properties of the skeletons or the functional groups of the resin constituting the particles thereof.

It is preferable that the maleic acid-based resin contain an acidic group such as a carboxyl group, a sulfonic acid group, or a phosphoric acid group. That is, the maleic acid-based resin contain an acidic group such as a carboxyl group, a sulfonic acid group, or a phosphoric acid group in the skeleton or the ester group in a state of an acid or a salt even when a carboxyl group derived from maleic acids is present in a state of an acid or a salt or all carboxyl groups derived from maleic acids are esterified. Further, the acidic group may be partially or entirely neutralized with ammonia, alkanolamine, or alkylamine.

Examples of a commercially available product of the maleic acid-based resin include SN Dispersant 5027 and 5029 (both manufactured by San Nopco Limited), SANSPARL PS-8 (manufactured by Sanyo Chemical Industries, Ltd.), MALIALIM HKM-50A, 150A, AKM-0531, SC-0505K, and POLYSTER OMA (all manufactured by NOF Corporation), DEMOL P, EP, ST, POIZ 520, and 521 (all manufactured by Kao Corporation), POLYTY A550 (manufactured by Lion Corporation), ARASTAR 7035, POLYMARON 1318, 351T, 385, 372, 375CB, 482, 482S, and 1329 (all manufactured by Arakawa Chemical Industries, Ltd.), XIRAN 1440H, 2625H, 1000H, 2000H, and 3000H (all manufactured by Polyscope), ISOBAM 104 (manufactured by Kuraray Co., Ltd.), and FLOWLEN G-700AMP and G-700DMEA (both manufactured by Kyoeisha Chemical Co., Ltd.).

The proportion of the water-soluble monomer in the molecular structure of the water-soluble resin is preferably 90% by mass or less, more preferably 80% by mass or less, still more preferably less than 60% by mass, and even still more preferably 50% by mass or less when the amount of all monomers of the water-soluble resin is set to 100% by mass. Further, the proportion of the water-soluble monomer in the molecular structure of the water-soluble resin is preferably 10% by mass or greater, more preferably 25% by mass or greater, still more preferably 30% by mass or greater, and even still more preferably 40% by mass or greater when the amount of all monomers of the water-soluble resin is set to 100% by mass.

When the proportion of the water-soluble monomer in the molecular structure of the water-soluble resin is less than the above-described ranges, the water solubility cannot be sufficiently obtained, and thus the water-soluble resin cannot be considered as a water-soluble polymer and stays in the form of a dispersion resin (resin particles). Meanwhile, when the proportion thereof is greater than the above-described ranges, the water-soluble resin is likely to be precipitated, and the clogging resistance may be degraded in a case where the moisture is evaporated, that is, the ink jet ink composition is in a hydrophobic state.

A water-soluble urethane-based resin denotes a water-soluble urethane resin containing a polar group in the molecular structure thereof. The polar group may be in a salt state. Further, it is preferable that the polar group be an acidic group. Examples of the acidic group include a carboxyl group, a sulfonic acid group, and a phosphorus-containing group such as a phosphoric acid group.

The water-soluble urethane-based resin has repeating units derived from a polyisocyanate and a polyol. Among such repeating units, the water-soluble urethane resin has preferably a repeating unit derived from a polyol containing an acid group and preferably repeating units each derived from a polyisocyanate, a polyol containing no acid group, and a polyol containing an acid group. The water-soluble urethane-based resin may further have a repeating unit derived from a polyamine.

A water-soluble polyester-based resin may be a resin having a polyester structure. Examples of the water-soluble resin as a nonionic water-soluble resin include polyethylene oxide, carboxymethyl cellulose, hydroxyethyl cellulose, polyvinylpyrrolidone, hydroxypropylmethyl cellulose, cellulose acetate, polyvinyl alcohol, and salts thereof.

The weight-average molecular weight Mw of the water-soluble resin is preferably 5,000 or greater and 150,000 or less, more preferably 10,000 or greater and 100,000 or less, still more preferably 15,000 or greater and 50,000 or less, even still more preferably 20,000 or greater and 30,000 or less, and even still more preferably 20,000 or greater and 23,000 or less.

When the molecular weight thereof is greater than or equal to the above-described lower limits, the viscosity of the ink jet ink composition can be more suitable, and for example, satisfactory color developability can be obtained. When the molecular weight thereof is less than or equal to the above-described upper limits, the viscosity of the ink jet ink composition can be more suitable in a case of using an ink jet method.

In the present specification, the molecular weight of the water-soluble resin is a molecular weight of a standard sample measured by a GPC method. The molecular weight may be performed with a single water-soluble resin or the ink jet ink composition containing the water-soluble resin. In this case, it is preferable that the components contained in the ink jet ink composition be specified.

The content of the water-soluble resin is preferably 0.1% by mass or greater and 10.0% by mass or less, more preferably 0.2% by mass or greater and 5.0% by mass or less, still more preferably 0.3% by mass or greater and 2% by mass or less, and even still more preferably 0.4% by mass or greater and 1.8% by mass or less. When the content of the water-soluble resin is in the above-described ranges, fixing properties of an image can be sufficiently obtained, and the clogging resistance is also more excellent.

In the ink jet ink composition according to the present embodiment, the amount of the water-soluble resin and the self-dispersing pigment to be blended is set such that the mass ratio of the self-dispersing pigment to the water-soluble resin (self-dispersing pigment/water-soluble resin) is set to 2.8 or greater and less than 30. Further, such a mass ratio is preferably 3.0 or greater and 28 or less, more preferably 3.2 or greater and 25 or less, still more preferably in a range of 3.5 to 20, even still more preferably 4.0 to 10.0, even still more preferably in a range of 5.0 to 8.0, and even still more preferably in a range of 5.5 to 7.0.

The rub resistance of an image is deteriorated when the amount of the water-soluble resin is small with respect to the amount of the self-dispersing pigment, and the clogging resistance is degraded when the amount of the water-soluble resin is large with respect to the amount of the self-dispersing pigment.

### 1.3. Betaine

The betaine is a compound in which positive and negative charges are present at non-adjacent positions in the same molecule and no dissociable hydrogen is bonded to the atom having the positive charges and which can constitute intramolecular salts and does not have charges as the entire molecule. In the present embodiment, it is preferable that a positively charge moiety of the betaine be a quaternary ammonium cation.

When the ink jet ink composition contains the betaine, flight deflection and jetting failure of the ink jet ink composition caused by the ink jet ink composition being dried in a nozzle of an ink jet head can be suppressed, and the clogging resistance can be improved. Further, as described above, a state in which the above-described water-soluble resin is incorporated in (absorbed by) the betaine is considered to be formed, and as a result, it is assumed that formation of foreign matter from the water-soluble resin is suppressed and resolubility can be obtained even in a case where the water-soluble resin is formed into foreign matter. In this manner, the clogging resistance is considered to be enhanced.

The betaine is not particularly limited, and examples thereof include trialkylglycine such as trimethylglycine or triethylglycine, γ-butyrobetaine, homarine, trigonelline, carnitine, homoserine betaine, valine betaine, lysine betaine, ornithine betaine, alanine betaine, stachydrine, and glutamic acid betaine. Among these, it is preferable that the glycine contained in the ink jet ink composition be selected from trialkylglycine and more preferable that the ink jet ink composition contain trimethylglycine.

The trialkylglycine is a compound in which the nitrogen atom of glycine has been substituted with three alkyl groups. In this manner, the clogging resistance is likely to be further improved. Further, the betaine may be used alone or in combination of two or more kinds thereof.

The number of carbon atoms constituting the betaine is preferably 4 or more and 12 or less, more preferably 4 or more and 7 or less, and still more preferably 4 or more and 6 or less. When the number of carbon atoms of the betaine is in the above-described ranges, the above-described effects tend to be more significant.

The content of the betaine is 2.5% by mass or greater and 9.5% by mass or less with respect to the total mass of the ink jet ink composition. Further, the content of the betaine is preferably 3% by mass or greater and 8% by mass or less and more preferably 4% by mass or greater and 6% by mass or less with respect to the total mass of the ink jet ink composition. When the content of the betaine is in the above-described ranges, formation of foreign matter from the water-soluble resin can be suppressed. When the content of the betaine is less than the above-described ranges, suppression of the water-soluble resin from being dried and solidified is likely to be insufficient, and the clogging resistance may be degraded. Further, when the content of the betaine is greater than the above-described ranges, the amount of the betaine to be dried and solidified when the betaine is dried tends to be increased, and the clogging resistance is degraded.

### 1.4. Water

The ink jet ink composition according to the present embodiment is an aqueous composition containing water. The term “aqueous” composition is a composition containing water as one of the main solvents. Examples of water include pure water such as ion exchange water, ultrafiltration water, reverse osmosis water, or distilled water, and ultrapure water which are obtained by reducing ionic impurities. Further, in a case where water sterilized by irradiation with ultraviolet rays, addition of hydrogen peroxide, or the like is used, generation of bacteria or fungi when the ink jet ink composition is stored for a long time can be suppressed.

The content of water is 30% by mass or greater, preferably 40% by mass or greater, more preferably 45% by mass or greater, and still more preferably 50% by mass or greater with respect to the total amount (100% by mass) of the ink jet ink composition. Further, the upper limit of the content of water is preferably 97% by mass or less, more preferably 90% by mass or less, still more preferably 85% by mass or less, and even still more preferably 80% by mass or less with respect to the total amount (100% by mass) of the ink composition.

### 1.5. Other Components

The ink jet ink composition according to the present embodiment may contain the following components in addition to the components described above.

### 1.5.1. Organic Solvent

The ink jet ink composition according to the present embodiment may contain an organic solvent. Examples of the organic solvent include alkyl polyol, glycol ether, and nitrogen-containing compounds. A water-soluble organic solvent is preferable as the organic solvent.

### 1.5.1.1. Alkyl Polyol

The ink jet ink composition according to the present embodiment may contain alkyl polyol. The alkyl polyol is a compound having a skeleton portion and containing two or more hydroxyl groups (substituted with two or more hydroxyl groups). Examples of the skeleton portion include an alkyl chain and a polyalkyleneoxy chain. The number of hydroxyl groups in a molecule is 2 or more, preferably 2 or more and 4 or less, and more preferably 2 or 3. The number of carbon atoms in a molecule is preferably 2 or more and 10 or less.

The concept of alkyl polyol includes polyhydric alcohol, but in a case where the ink jet ink composition contains alkyl polyol, the moisture retaining properties of the ink jet ink composition are enhanced, and the moisture evaporation from a recording head when allowed to stand for a long time can be effectively suppressed while the jetting stability using an ink jet method is improved. Further, in this manner, even when a coloring material of a type that is likely to be cause clogging of a nozzle is used, the property of recovery after standing and the continuous jetting stability can be more satisfactorily maintained.

Specific examples of the alkyl polyol include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, diethylene glycol, propylene glycol, dipropylene glycol, glycerin, triethylene glycol, and tetraethylene glycol. These alkyl polyols may be used alone or in combination of two or more kinds thereof.

Among the alkyl polyols, it is more preferable that the ink jet ink composition contain alkanediol having 3 or more and 6 or less carbon atoms. Examples of the alkanediol having 3 or more and 6 or less carbon atoms include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-1,3-propanediol, 2,2-dimethyl-1,3-propanediol, 3-methyl-1,3-butanediol, 3-methyl-1,5-pentanediol, and 2-methylpentane-2,4-diol.

When the ink jet ink composition contains the alkanediol having 3 or more and 6 or less carbon atoms, an increase in viscosity is further suppressed, and the jetting stability (continuous jetting reliability) can be more satisfactorily increased. Further, the solubility and the dispersibility of the coloring material are likely to be enhanced, and satisfactory clogging recovering properties can be obtained.

When the ink jet ink composition contains the alkyl polyol, it is more preferable that the ink jet ink composition contain polyols having a standard boiling point of higher than 280° C. Examples of the polyols having a standard boiling point of higher than 280° C. include glycerin and triethylene glycol. When the ink jet ink composition contains such polyols, an increase in drying speed of the ink jet ink composition can be suppressed, and the clogging resistance and the jetting stability can be further enhanced.

When the alkyl polyol is used, the content thereof is preferably 2% by mass or greater and 30% by mass or less, more preferably 5% by mass or greater and 20% by mass or less, and still more preferably 8% by mass or greater and 15% by mass or less with respect to the total amount of the ink jet ink composition.

### 1.5.1.2. Glycol Ether

The ink jet ink composition according to the present embodiment may contain glycol ether. Examples of the glycol ether include monoalkyl ether and dialkyl ether of glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. More specific examples thereof include methyl triglycol (triethylene glycol monomethyl ether), butyl triglycol (triethylene glycol monobutyl ether), butyl diglycol (diethylene glycol monobutyl ether), and dipropylene glycol monopropyl ether, and typical examples thereof include diethylene glycol monobutyl ether.

Among the glycol ethers, it is still more preferable that the ink jet ink composition contain one or more kinds selected from glycol ether represented by Formula (1).

R¹—O—(CH₂—CH₂—O)ₙ—R² (1)

(In Formula (1), R₁ represents H or an alkyl group having 1 or more and 4 or less carbon atoms, R² represents an alkyl group having 1 or more and 4 or less carbon atoms, and n represents an integer of 2 or greater and 3 or less.)

Examples of the glycol ether represented by Formula (1) include methyl triglycol (triethylene glycol monomethyl ether), butyl triglycol (triethylene glycol monobutyl ether), butyl diglycol (diethylene glycol monobutyl ether), triethylene glycol dimethyl ether, triethylene glycol dibutyl ether, and diethylene glycol dibutyl ether.

The glycol ether may be used in the form of a mixture of a plurality of kinds thereof. From the viewpoint of adjusting the viscosity of the ink jet ink composition and suppressing clogging due to the moisture retaining effect, the amount thereof to be blended is 0.5% by mass or greater and 30% by mass or less, preferably 1.0% by mass or greater and 20% by mass or less, and more preferably 3.0% by mass or greater and 10.0% by mass or less with respect to the total amount of the ink jet ink composition.

### 1.5.1.3. Nitrogen-Containing Compounds

The ink jet ink composition according to the present embodiment may contain nitrogen-containing compounds. The nitrogen-containing compounds can be expected to have an effect of suppressing the ink jet ink composition from being solidified or dried. For example, amides are preferable as the nitrogen-containing compounds. Examples of the amides include a cyclic amide and an acyclic amide.

Examples of the cyclic amide include a compound having a ring structure that contains an amide group. Examples of such a compound include γ-lactams such as 2-pyrrolidone, 1-methyl-2-pyrrolidone (N-methyl-2-pyrrolidone), 1-ethyl-2-pyrrolidone (N-ethyl-2-pyrrolidone), 1-propyl-2-pyrrolidone, 1-butyl-2-pyrrolidone, and N-vinyl-2-pyrrolidone (NVP), β-lactams, δ-lactams, and ε-lactams such as ε-caprolactam. These cyclic amides may be used alone or in combination of two or more kinds thereof.

### 1.5.1.4. Other Organic Solvents

The ink jet ink composition according to the present embodiment may contain other organic solvents. Examples of the other organic solvents include lactones such as γ-butyrolactone and a betaine compound.

The content of the organic solvent is preferably 2% by mass or greater and 30% by mass or less, more preferably 5% by mass or greater and 20% by mass or less, and still more preferably 8% by mass or greater and 15% by mass or less with respect to the total amount of the ink jet ink composition.

### 1.5.2. Resin Particles

The ink jet ink composition may contain resin particles. The resin particles will also be referred to as a dispersion resin. Since the resin particles are likely to cause degradation of the clogging resistance, the content of the resin particles when the ink jet ink composition contains the resin particles is preferably 1% by mass or less, more preferably 0.5% by mass or less, still more preferably 0.3% by mass or less, even still more preferably 0.1% by mass or less, and particularly preferably less than 0.1% by mass with respect to the total mass of the ink jet ink composition. For the same reason as described above, it is more preferable that the ink jet ink composition contain no resin particles.

When the ink contains resin particles, the ink is easily foamed and thus air bubbles are likely to be formed due to the surfactant (dispersant) for dispersing the resin. Air bubbles are likely to be formed particularly when the ink storage container is filled with the ink from the ink filling hole. Further, the resin particles are likely to be formed into foreign matter at the gas-liquid interface inside the ink storage container.

Further, when air bubbles are formed, the number of gas-liquid interfaces is increased, and thus foreign matter is likely to be formed at the gas-liquid interfaces. Further, since the resin particles are not soluble in water, there are concerns of environmental problems due to microplastics when the ink flows out to the natural environment. Examples of the resin dispersion include a dispersion resin dispersed by a surfactant and a soap-free dispersion resin dispersed without using a surfactant.

### 1.5.3. Surfactant

The ink jet ink composition according to the present embodiment may contain a surfactant. The surfactant can be used for reducing the surface tension of the ink jet ink composition to adjust and improve the wettability with respect to a recording medium and the permeability into, for example, fabrics. As the surfactant, any of nonionic surfactant, an anionic surfactant, a cationic surfactant, or an amphoteric surfactant can be used, and these surfactants may be used in combination. Further, among the surfactants, an acetylene glycol-based surfactant, a silicone-based surfactant, and a fluorine-based surfactant can be more preferably used.

The acetylene glycol-based surfactant is not particularly limited, and examples thereof include SURFYNOL 104, 104E, 104H, 104A, 104BC, 104DPM, 104PA, 104PG-50, A104S, 420, 440, 465, 485, SE, SE-F, 504, 61, DF37, CT111, CT121, CT131, CT136, TG, GA, and DF110D (all trade names, manufactured by Air Products and Chemicals Inc.), OLFINE B, Y, P, A, STG, SPC, E1004, E1010, PD-001, PD-002W, PD-003, PD-004, PD-005, EXP. 4001, EXP. 4036, EXP. 4051, EXP. 4123, EXP. 4200, EXP. 4300, D-10PG, AF-103, AF-104, AK-02, SK-14, and AE-3 (all trade names, manufactured by Nissin Chemical Co., Ltd.), and ACETYLENOL E00, E00P, E40, and E100 (all trade names, manufactured by Kawaken Fine Chemicals Co., Ltd.).

The silicone-based surfactant is not particularly limited, and preferred examples thereof include a polysiloxane-based compound. The polysiloxane-based compound is not particularly limited, and examples thereof include polyether-modified organosiloxane. Examples of a commercially available product of the polyether-modified organosiloxane include BYK-306, BYK-307, BYK-333, BYK-341, BYK-345, BYK-346, and BYK-348 (all trade names, manufactured by BYK-Chemie Japan K.K.), and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all trade names, manufactured by Shin-Etsu Chemical Co., Ltd.).

As the fluorine-based surfactant, a fluorine-modified polymer is preferably used, and examples thereof include BYK-340 (trade name, manufactured by BYK-Chemie Japan K.K.).

When the surfactant is blended into the ink jet ink composition, the content of the surfactant is 0.01% by mass or greater and 3% by mass or less, preferably 0.05% by mass or greater and 2% by mass or less, more preferably 0.1% by mass or greater and 1.5% by mass or less, and particularly preferably 0.2% by mass or greater and 1% by mass or less with respect to the total amount of the ink jet ink composition.

When the surfactant is blended into the ink jet ink composition, it is more preferable to select a surfactant having defoaming properties. Air bubbles are unlikely to be formed by allowing the ink jet ink composition to contain a surfactant having defoaming properties, and for example, the stability when the ink is jetted from a head tends to increase.

### 1.5.4. Chelating Agent

The ink jet ink composition according to the present embodiment may use a chelating agent. The chelating agent is capable of removing predetermined ions from the ink jet ink composition.

Examples of the chelating agent include ethylenediaminetetraacetic acid and salts thereof such as EDTA, ethylenediaminetetraacetic acid disodium salt dehydrate (EDTA-2Na), ethylenediaminetetraacetic acid trisodium salt monohydrate (EDTA-3Na), ethylenediaminetetraacetic acid tetrasodium salt (EDTA-4Na), and ethylenediaminetetraacetic acid tripotassium salt monohydrate (EDTA-3K), diethylenetriaminetetraacetic acid and salts thereof such as DTPA, diethylenetriaminetetraacetic acid disodium salt (DTPA-2Na) and diethylenetriaminetetraacetic acid pentasodium salt (DTPA-5Na), nitrilotriacetic acid and salts thereof such as NTA, nitrilotriacetic acid disodium salt (NTA-2Na) and nitrilotriacetic acid trisodium salt (NTA-3Na), ethylenediamine-N,N′-disuccinic acid and salts thereof, 3-hydroxy-2,2′-iminodisuccinic acid and salts thereof, L-aspartic acid-N,N′-diacetic acid and salts thereof, L-glutamic acid diacetic acid and salts thereof, N-(1-carboxylatomethyl)iminodiacetic acid and salts thereof, and N-(2-hydroxyethyl)iminodiacetic acid and salts thereof.

Further, examples of the chelating agent other than acetic acid analogues include ethylenediaminetetramethylenephosphonic acid and salts thereof, ethylenediaminetetrametaphosphoric acid and salts thereof, ethylenediaminepyrophosphoric acid and salts thereof, and ethylenediaminemetaphosphoric acid and salts thereof.

When the ink jet ink composition according to the present embodiment contains the chelating agent, one or two or more kinds selected from the above-described examples can be used.

### 1.5.5. pH Adjuster

A pH adjuster can be added to the ink jet ink composition according to the present embodiment. The pH adjuster is not particularly limited, and examples thereof include appropriate combinations of acids, bases, weak acids, and weak bases. As the acids and the bases used in such combinations, examples of inorganic acids include sulfuric acid, hydrochloric acid, and nitric acid, examples of inorganic bases include lithium hydroxide, sodium hydroxide, potassium hydroxide, potassium dihydrogen phosphate, disodium hydrogen phosphate, potassium carbonate, sodium carbonate, sodium hydrogen carbonate, sodium hydrogen carbonate, and ammonia, examples of organic bases include triethanolamine, tripropanolamine, diethanolamine, monoethanolamine, triisopropanolamine, diisopropanolamine, and trishydroxymethylaminomethane (THAM), and examples of organic acids include adipic acid, citric acid, succinic acid, lactic acid, good buffers such as N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), morpholinopropanesulfonic acid (MOPS), carbamoylmethyliminobisacetic acid (ADA), piperazine-1,4-bis(2-ethanesulfonic acid) (PIPES), N-(2-acetamido)-2-aminoethanesulfonic acid (ACES), cholamine chloride, N-tris(hydroxymethyl)methyl-2-aminoethanesulfonic acid (TES), acetamidoglycine, tricine, glycinamide, and bicine, a phosphate buffer solution, a citrate buffer solution, and a tris buffer solution. Further, among these, the ink jet ink composition contains a tertiary amine such as triethanolamine or triisopropanolamine, and a carboxyl group-containing organic acid such as adipic acid, citric acid, succinic acid, or lactic acid as a part or the entirety of the pH adjuster, which is preferable from the viewpoint of more stably obtaining a pH buffering effect.

### 1.5.6. Ureas

As a moisturizing agent of the ink jet ink composition, ureas may be used as a dyeing assistant that improves dyeing properties of a dye. Specific examples of the ureas include urea, ethylene urea, tetramethyl urea, thiourea, and 1,3-dimethyl-2-imidazolidinone. When the ink jet ink composition contains ureas, the content thereof can be set to 1% by mass or greater and 10% by mass or less with respect to the total mass of the ink jet ink composition.

### 1.5.7. Preservative, Fungicide, and Rust Inhibitor

The ink jet ink composition may use a preservative and a fungicide. Examples of the preservative and the fungicide include sodium benzoate, sodium pentachlorophenol, sodium 2-pyridinethiol-1-oxide, sodium sorbate, sodium dehydroacetate, 1,2-dibenzoisothiazolin-3-one (PROXEL CRL, PROXEL BDN, PROXEL GXL, PROXEL XL-2, PROXEL TN, and PROXEL LV, manufactured by Zeneca Inc.), and 4-chloro-3-methylphenol (PREVENTOL CMK and the like, manufactured by Bayer AG). Examples of the rust inhibitor include benzotriazole.

### 1.5.8. Saccharides

The ink jet ink composition may contain saccharides. Specific examples of the saccharides include glucose, mannose, fructose, ribose, xylose, arabinose, galactose, aldonic acid, glucitol (sorbitol), maltose, cellobiose, lactose, sucrose, trehalose, and maltotriose.

### 1.5.9. Other Components

The ink jet ink composition may further contain, as other components in addition to the above-described components, additives that can be typically used in an ink jet ink composition for ink jet, such as an antioxidant, an ultraviolet absorbing agent, and a dissolution assistant.

### 1.6. Applications and the Like

The ink jet ink composition according to the present embodiment is used by an ink jet recording device including an ink storage container that has an ink filling hole. Hereinafter, the ink jet recording device including an ink storage container that has an ink filling hole will be described.

The ink jet recording device is an ink jet recording device that includes the above-described ink jet ink composition, an ink storage container in which the ink jet ink composition is stored, and a recording head jetting the ink jet ink composition, and the ink storage container has an ink filling hole used to be filled with the ink jet ink composition and configured to be opened and closed. The ink jet recording device includes the above-described ink jet ink composition.

The ink jet recording device includes the above-described ink jet ink composition, an ink storage container in which the ink jet ink composition is stored, and a recording head jetting the ink jet ink composition, and the ink storage container has an ink filling hole used to be filled with the ink jet ink composition and configured to be opened and closed.

An example of the ink jet recording device according to the present embodiment will be described with reference to the accompanying drawings. Further, the ink storage container is an ink tank of a printer (ink jet recording device) that performs recording (printing) of an image or the like on a medium by jetting an ink to the medium. Further, in the description below, the ink jet recording device will also be simply referred to as a recording device, and the ink jet ink composition will also be simply referred to as an ink.

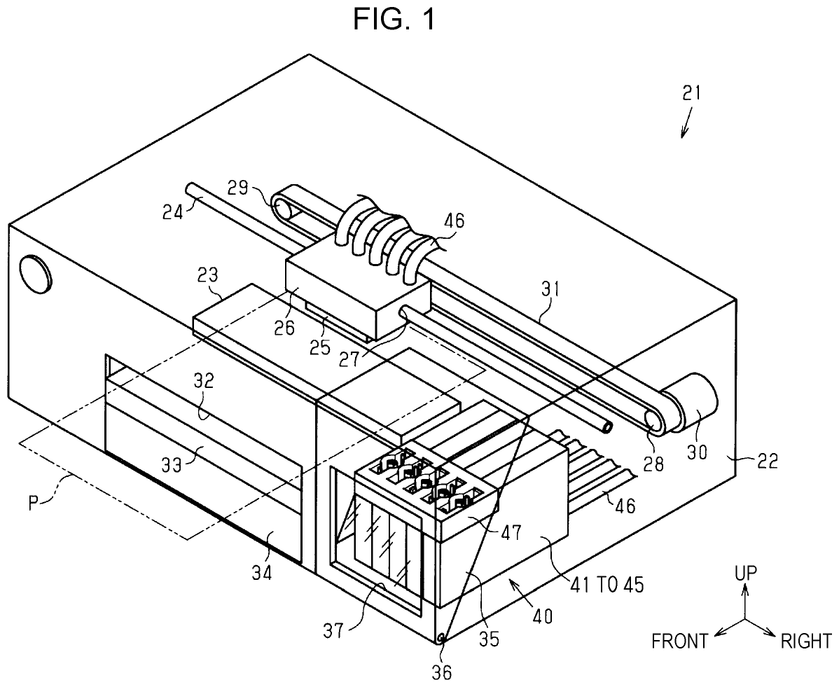

As shown in FIG. 1, a recording device 21 includes a rectangular parallelepiped housing 22 in which the left-right direction thereof is set as the longitudinal direction. Further, FIG. 1 schematically shows the inside the housing 22 of the recording device 21 in a see-through state. A support stand 23 in which the left-right direction is set as the longitudinal direction is provided in a rear lower portion of the housing 22 such that the upper surface thereof is disposed in an approximately horizontal direction. Paper P as an example of a medium is conveyed forward which is a conveyance direction while being supported by the upper surface of the support stand 23. A guide shaft 24 extending in the left-right direction is provided at the upper position of the support stand 23 inside the housing 22, and a carriage 26 that has, on a lower surface side thereof, a recording head 25 (ink jet head) jetting the ink is supported by the guide shaft 24. That is, the carriage 26 is reciprocatably supported by the guide shaft 24 in the left-right direction in a state where the guide shaft 24 is inserted into a support hole 27 penetrating through the carriage 26 in the left-right direction.

Further, a drive pulley 28 and a driven pulley 29 are rotatably supported at positions in the vicinity of both ends of the guide shaft 24 inside the housing 22. An output shaft of a carriage motor 30 is connected to the drive pulley 28, and an endless timing belt 31 that is partially connected to the carriage 26 is wound between the drive pulley 28 and the driven pulley 29. Further, when the carriage 26 reciprocates due to the driving of the carriage motor 30 in the left-right direction which is the scanning direction on the paper P while being guided by the guide shaft 24 through the timing belt 31, the ink is jetted to the paper P conveyed forward on the support table 23 from the recording head 25 disposed on the lower surface side of the carriage 26.

Further, the recording device may be a serial type recording device that performs recording by allowing a recording head to jet the ink while a carriage included in the recording head moves as shown in FIG. 1. Alternatively, the recording head may be a line type recording head that performs recording by allowing a recording head that is a line head having a length greater than or equal to a recording width of a recording medium to jet the ink.

Further, as shown in FIG. 1, a rectangular discharge port 32 that discharges, to the front side, the paper P on which recording has been performed by allowing the recording head 25 to jet the ink when the paper P is conveyed on the support stand 23 inside the housing 22 is opened at a position which is the front side of the support stand 23 on the front surface side of the housing 22. The discharge port 32 is provided with a rectangular plate-like discharge tray 33 configured to support the paper P discharged from the housing 22 such that the discharge tray 33 is projectable to and retractable from the front side in the discharge direction. Further, a paper feed cassette 34 configured to store a plurality of sheets of paper P used for recording an image in a laminated state is attached onto the lower side of the discharge tray 33 in the discharge port 32 such that the paper feed cassette 34 is freely inserted and removed in a front and rear direction.

Further, as shown in FIG. 1, an opening/closing door 35 having rectangular front and upper surfaces and a right angled triangular right side is provided at a position which is the front surface of the housing 22 and on an end portion side (a right end portion side in FIG. 1) of the discharge port 32 in the left-right direction such that the opening/closing door 35 is freely opened and closed in the front and rear direction using, as the center of rotation, the rotation shaft 36 provided at the lower end of the opening/closing door 35 in the left-right direction. A window portion 37 formed of a rectangular transparent member is formed at the front surface of the opening/closing door 35 such that a user can visually recognize the inside of the housing 22 (particularly, the rear side of the front surface of the opening/closing door 35) in a state where the opening/closing door 35 is closed.

An ink supply unit 40 that supplies the ink to the recording head 25 is stored at a position which is a rear side of the opening/closing door 35, that is, a position closer to the front surface and closer to an end portion (in this case, closer to a right end portion) inside the housing 22 of the recording device 21. The ink supply unit 40 is a structure including a plurality (five in the present embodiment) of ink storage containers 41 to 45 and configured to be integrally handled, and each of the ink storage containers 41 to 45 can replenish the ink as described above.

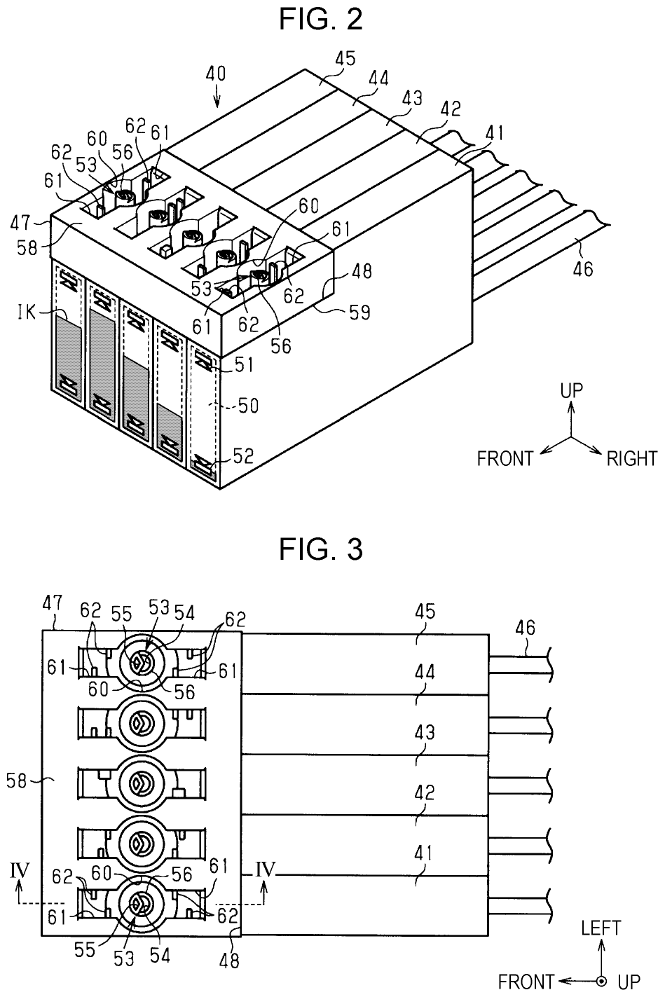

As shown in FIGS. 2 and 3, the ink supply unit 40 includes five modified box-shaped ink storage containers 41 to 45 which are long in the front and rear direction, five ink supply pipes 46 pulled from the rear surface side of each of the ink storage containers 41 to 45, and a rectangular parallelepiped adapter 47 for ink replenishment which is assembled with a collection of the ink storage containers 41 and 45. The adapter 47 for ink replenishment is integrated with the ink storage containers 41 to 45 by being assembled with a stepped portion 48 formed in a notch in an upper front half portion of all the ink storage containers 41 to 45 in a state where all the ink storage containers 41 to 45 are arranged side by side by setting the width direction as the left-right direction. Further, as shown in FIG. 1, the ink supply pipes 46 pulled out from the ink storage containers 41 to 45 are connected to an ink flow passage (not shown) formed in the carriage 26 and connected to the recording head 25 through this ink flow passage. Further, the adapter 47 for ink replenishment may constitute a part of the housing 22 covering the ink storage containers 41 to 45 or may be formed integrally with the ink storage containers 41 to 45.

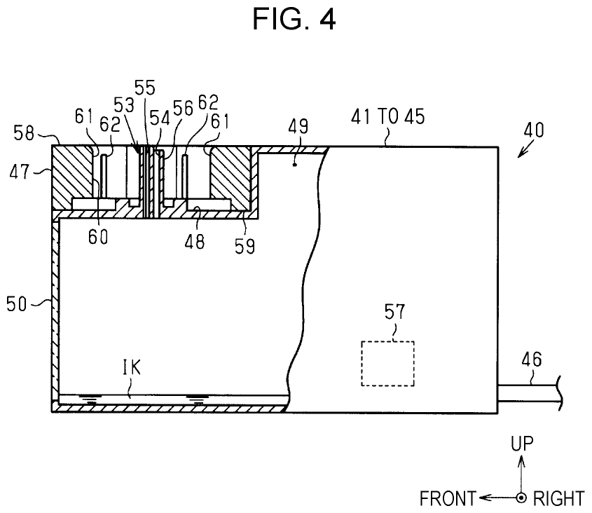

As shown in FIG. 4, the ink storage containers 41 to 45 each have an ink storage chamber 49 configured to store an ink composition IK in the inside thereof. In a case of the present embodiment, a black ink is stored in the ink storage chamber 49 of the ink storage container 41 positioned at the right end in the lateral direction. Further, an ink of a color (cyan, magenta, yellow, or the like) other than black is stored in the ink storage chamber 49 of each of the ink storage containers 42 to 45 arranged on a left side of the ink storage container 41 positioned at the right end in the lateral direction. Further, a viewing portion 50 formed of a transparent resin that enables visual recognition of the liquid level of the ink composition IK inside the ink storage chamber 49 is provided on a front wall portion that is visually recognizable through a window portion 37 on the front surface of the housing 22 in the ink storage container 41 to 45. In addition, an upper limit mark 51 indicating the standard of the upper limit of the liquid level of the ink composition IK stored in the ink storage chamber 49 (example of a standard amount of the ink that can be poured without overflowing from the ink filling hole 53) and a lower limit mark 52 indicating the standard of the lower limit thereof (for example, a standard to prompt ink replenishment) are provided in the viewing portion 50.

As shown in FIG. 4, an ink inlet 53 (ink filling hole) configured to be opened and closed and to enable inflow of the ink from the outside to the inside of the ink storage chamber 49 is provided on the upper side of a horizontal portion of the stepped portion 48 in the ink storage containers 41 to 45. The ink inlet 53 is formed to include a needle 56 having flow passages 54 and 55 that makes the inside and outside of the ink storage chamber 49 communicate with each other and extending in the vertical direction. The flow passages 54 and 55 of the needle 56 are two flow passages 54 and 55 disposed side by side in a radiation direction in which each of tip openings is centered on the needle 56, and one flow passage 54 (right side in FIG. 4) of these two flow passages 54 and 55 has a tip opening with a height less than that of the other flow passage 55 (left side in FIG. 4), and the flow passage thereof is formed to have a large cross-sectional area. Further, a remaining amount sensor 57 for detecting the remaining amount of the ink composition IK inside the ink storage chamber 49 is provided in a lower portion close to a rear side in the ink storage chamber 49. Further, the remaining amount sensor 57 may not be provided.

As shown in FIGS. 2 to 4, an upper surface 58 of the adapter 47 for ink replenishment is a horizontal surface in a direction orthogonal (intersecting) to a direction in which the needle 56 extends, and a through-hole 60 penetrating from a lower surface 59 in the vertical direction is formed at the upper surface 58 thereof as an ink inlet forming portion. This through-hole 60 is formed of the ink inlet 53 having a circular hole shape in which the needle 56 is disposed at the center thereof and a pair of front and rear rectangular holes at the front and rear side of the ink inlet 53, which are connected to each other, and an opening on the lower side thereof is blocked by the horizontal portion of the stepped portion 48 in which the needle 56 protrudes upward in the ink storage containers 41 to 45.

Therefore, a pair of front and rear recesses 61 that are open upwardly in a direction in which the needle 56 extends are formed to be recessed in a point-symmetrical manner with respect to the ink inlet 53 by defining the vertically downward direction as the depth direction using a pair of front and rear rectangular holes with a blocked lower opening, in a region outside the ink inlet 53 in a radiation direction centering on the ink inlet 53 in the through-hole 60. That is, a plurality (two pairs of front and rear recesses in this case) of recesses 61 are formed in a point-symmetrical manner with respect to the ink inlet 53 in a region outside the ink inlet 53 including the needle 56 in the adapter 47 for ink replenishment that is integrated with the ink storage containers 41 to 45. Further, in this case, the tip of the needle 56 disposed at the center of the circular ink inlet 53 having a circular hole shape is positioned on a side of the ink storage chamber 49 with respect to the upper surface 58 of the adapter 47 for ink replenishment, which is an opening edge of the through-hole 60 including the ink inlet 53 and the recess 61. That is, the upper surface 58 of the adapter 47 for ink replenishment extends in a direction intersecting the direction in which the needle 56 extends at a position outside the tip of the needle 56 in the direction in which the needle 56 extends. Meanwhile, the lower surface 59 of the adapter 47 for ink replenishment functions as a tank engaging portion that is engaged with a collection of the plurality of ink storage containers 41 to 45 arranged side by side in the left-right direction from the upper side.

Further, a peripheral portion of the opening edge on the upper side of each through-hole 60 on the upper surface 58 of the adapter 47 for ink replenishment is colored in a specific color. That is, the peripheral portion is colored in the same color as the color of the ink stored in the ink storage chamber 49 of the ink storage containers 41 to 45 into which the ink flows through the ink inlet 53 of the through-hole 60. From this viewpoint, the peripheral portion of the opening edge on the upper side of each through-hole 60 in the adapter 47 for ink replenishment functions as a first portion showing, to the outside, information related to the ink stored inside the ink storage containers 41 to 45 communicating with the ink inlet 53 of the through-hole 60 and the ink storage chamber 49. In addition, the in stored in the ink storage containers 41 to 45 is not particularly limited, but when the ink storage container storing the ink composition according to the present embodiment is defined as the ink storage container 41, the ink storage container 41 stores a black ink or a gray ink, and thus the peripheral portion of the upper opening of the through-hole 60 in which the ink inlet 53 communicating with the ink storage chamber 49 of the ink storage container 41 is disposed is colored in black or gray.

Further, a first uneven portion (first key structure portion) 62 having a characteristic uneven shape in the horizontal direction is provided to extend in a depth direction (that is, a direction of the central axis of the ink inlet 53) of the recess 61, at a position on a bottom surface side (that is, a horizontal portion side of the stepped portion 48) with respect to the opening edge on the upper side of the recess 61 on the inner surface (specifically, the inside surface in the vertical direction) of the recess 61. As shown in FIGS. 2 and 3, the first uneven portion 62 is provided for each ink inlet 53 of the plurality (five in the present embodiment) of ink storage containers 41 to 45. Therefore, in the adapter 47 for ink replenishment, a first uneven portion 62 different from a first uneven portion 62 provided on the inner surface of the recess 61 of another through-hole 60 is formed for each through-hole 60 in the rectangular recess 61 in each through-hole 60 formed at a position corresponding to each of the ink storage containers 41 to 45 in the vertical direction. That is, these first uneven portions 62 function as an identification unit configured to identify an ink bottle 63 having an ink outlet 65 connected to the ink inlet 53 inside the through-hole 60 in which each first uneven portion 62 is formed. Further, the expression of “position on a bottom surface side with respect to the opening edge on the upper side of the recess 61” denotes a position that can be slightly retreated to the bottom surface side with respect to the opening edge.

Next, the ink bottle 63 will be described as an ink replenishment container that constitutes an ink replenishment system together with the ink storage containers 41 to 45 and replenishes the ink to the ink storage containers 41 to 45 when the remaining amount the ink is low. The above-described ink jet ink composition is stored in the ink bottle 63.

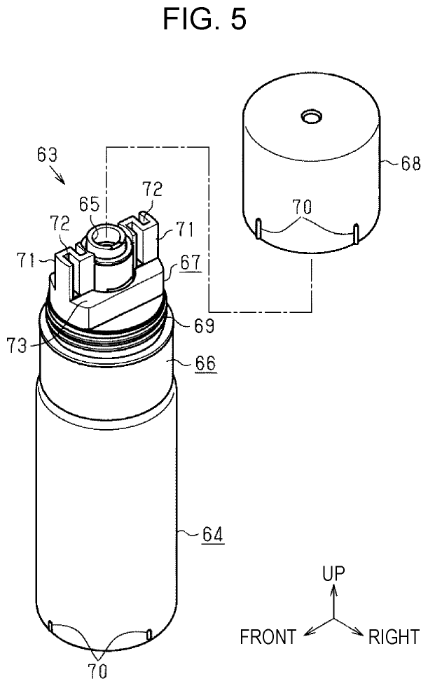

As shown in FIG. 5, the ink bottle 63 includes a cylindrical container main body portion 64 serving as a main component of the ink bottle 63, an ink outlet forming portion 66 which is provided at a tip portion of the container main body portion 64 and in which an ink outlet 65 configured to allow the ink to flow out from the inside of the ink bottle 63 has a tip at which an opening is formed, and a container addition portion 67 added to the ink outlet forming unit 66 to surround the ink outlet 65. The ink outlet 65 of the ink outlet forming unit 66 and the container addition portion 67 in the periphery of the ink outlet 65 are covered with a bottomed cylindrical cap 68 and thus are hidden from the outside when the ink bottle 63 is stored. That is, a female thread portion (not shown) is formed at the inner peripheral surface of the cap 68 while a male thread 69 is formed at the outer peripheral surface of the cylindrical lower end portion of the container addition portion 67, the female thread portion of the cap 68 is screwed to the male thread portion 69 of the container addition portion 67 so that the cap 68 is attached to the tip portion of the ink bottle 63 to cover the ink outlet 65.

Further, the entire outer surface of the container addition portion 67 is colored in a specific color. That is, the container addition portion 67 is colored in the same color as the color of the ink stored in the container main body portion 64 to which the container addition portion 67 is added. In addition, the outer surface of the container addition portion 67 in the ink bottle 63 storing a black or gray ink is colored in black or gray. Further, a plurality (four in the present embodiment) of protrusions 70 are formed at equal angular intervals (for example, at intervals of 90 degrees) on the outer peripheral surface of each base end portion of the container main body portion 64 and the cap 68. In addition, these protrusions 70 are formed to prevent the cylindrical ink bottle 63 from rolling. Further, for example, the container main body portion 64 of the ink bottle 63 storing a black color may be formed to be thicker than the container main body portions 64 of the ink bottles 63 storing inks of other colors. In this case, the ink outlet forming portion 66 for a black ink may be formed to have the same thickness and the same shape as those for inks of other colors.

The material of the container main body portion 64 is not limited, and plastics, metals, glass, or the like can be used. Among these, from the viewpoint of being lightweight, plastics are preferable. Among the plastics, soft plastic is preferable. The soft plastic is plastic that can be dent when both sides of the container main body portion 64 are pinched by hand. The container main body portion 64 formed of soft plastic is preferable from the viewpoint that the ink is likely to be pushed out from the ink outlet 65 by turning the container main body portion 64 upside down and pinching both sides of the container main body portion 64 between fingers so that the container main body portion 64 is dented.

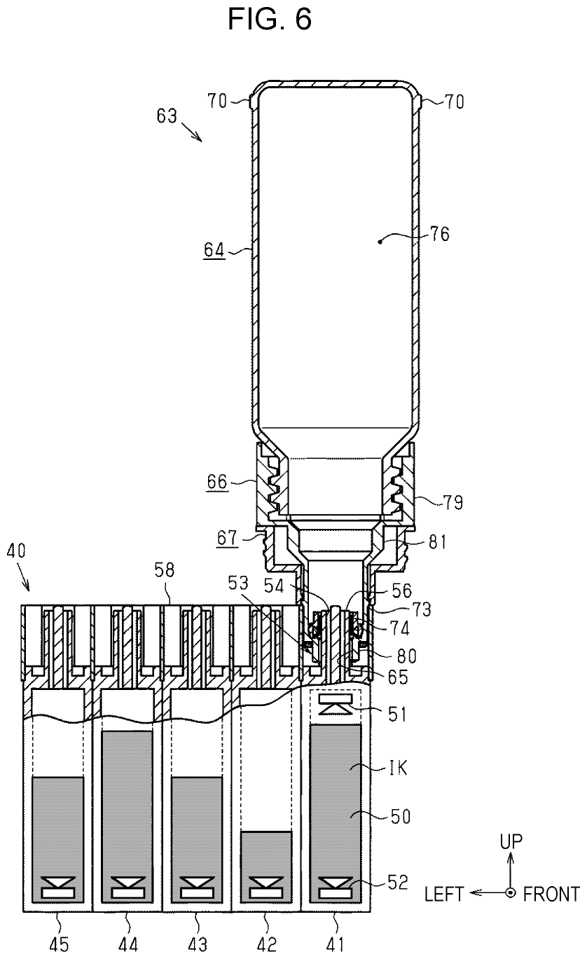

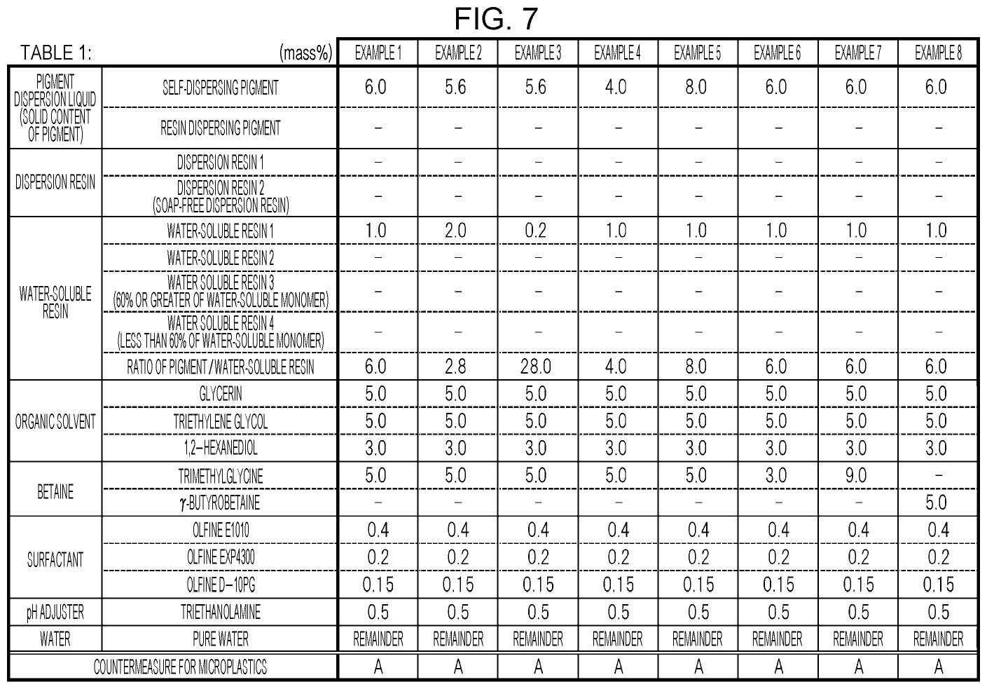

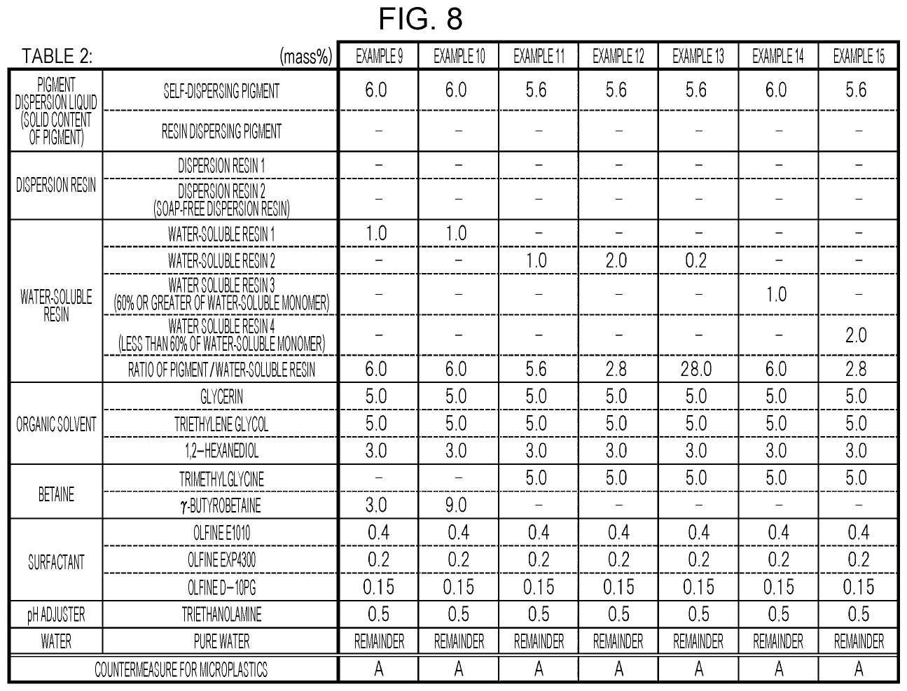

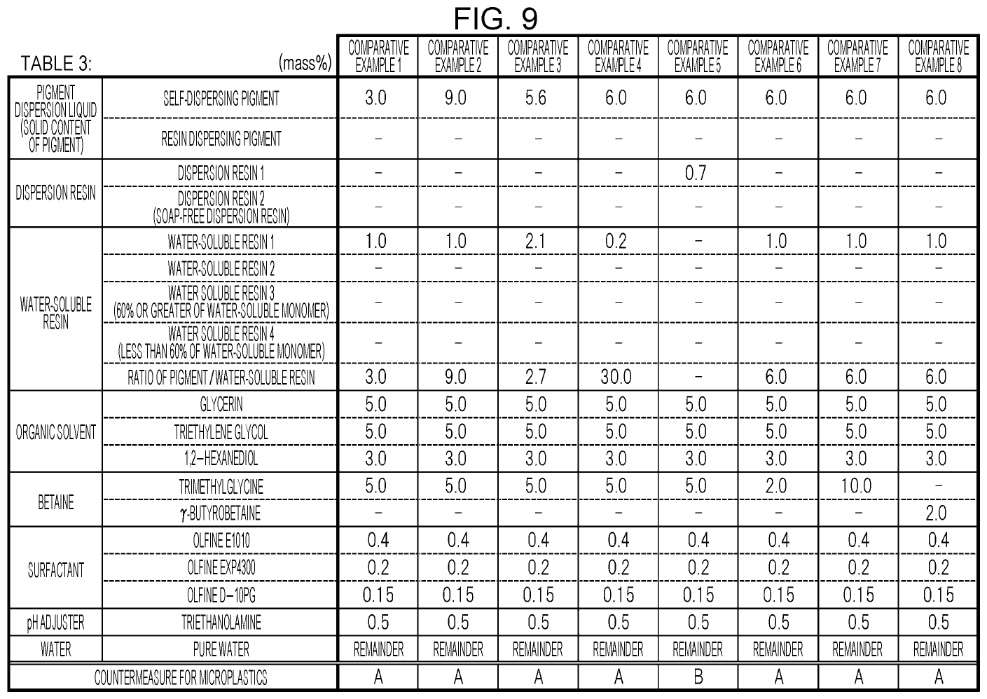

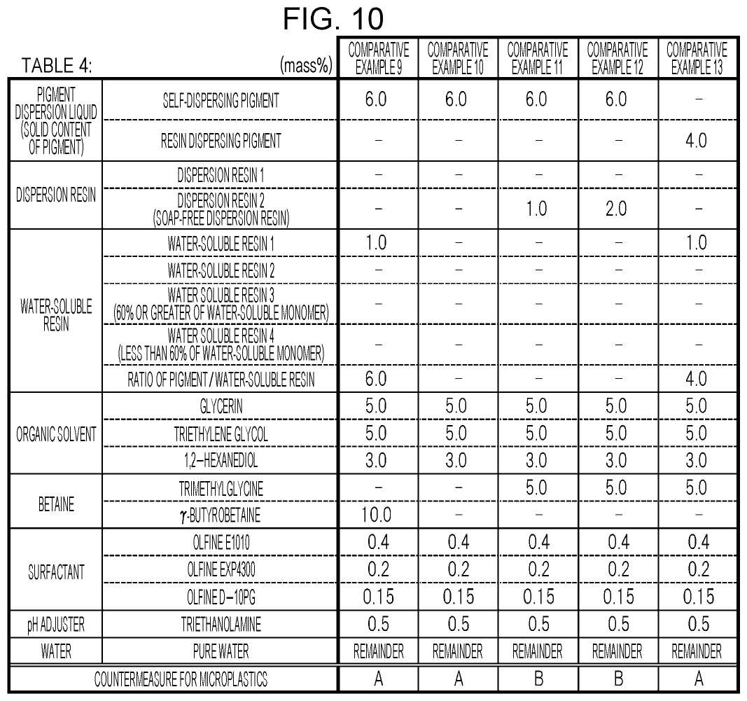

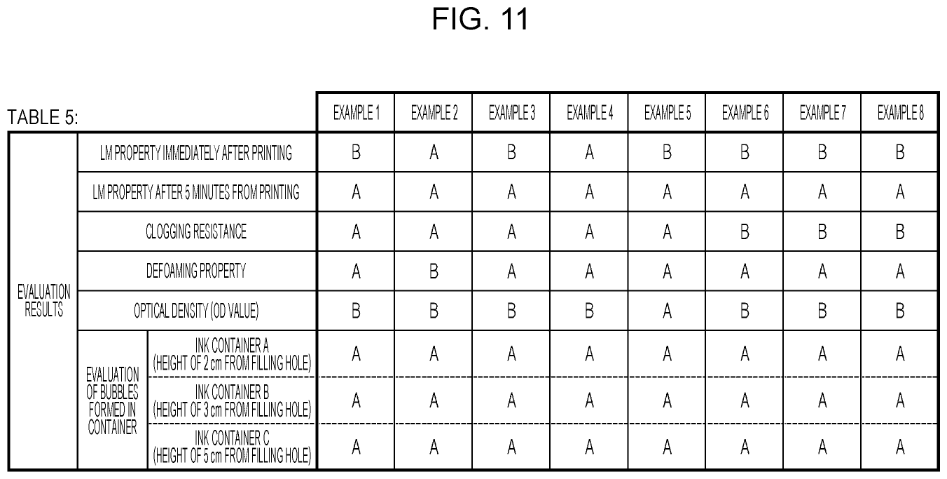

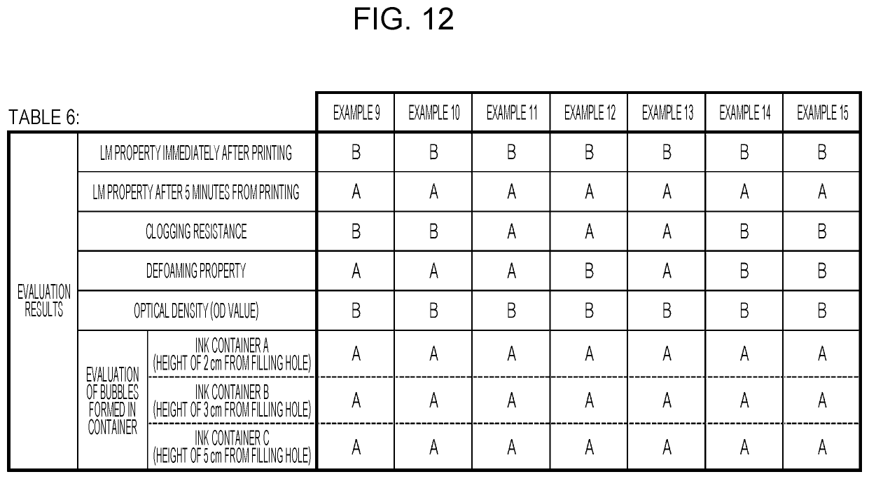

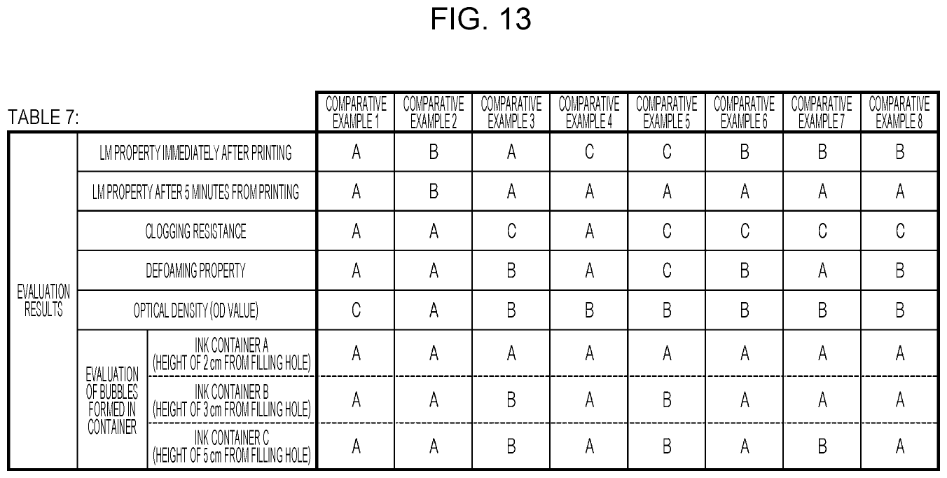

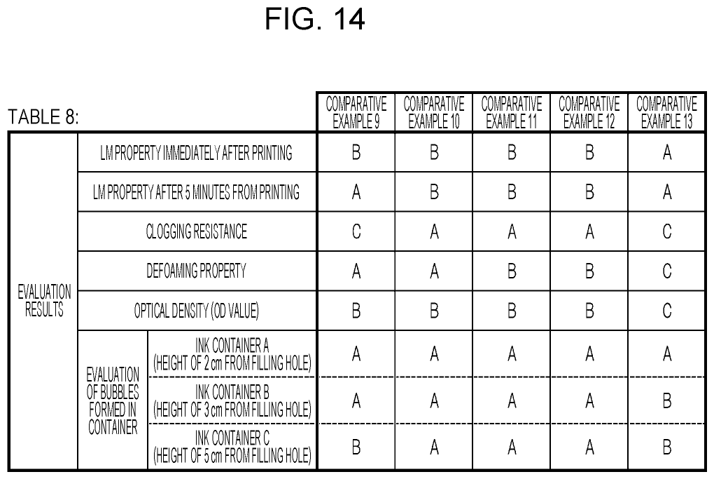

As shown in FIG. 6, the user holds the ink bottle 63 such that the ink outlet 65 is positioned above the through-hole 60 on the rightmost side in the adapter 47 for ink replenishment by turning the ink bottle 63 storing the ink composition used for ink replenishment upside down. That is, the central axis line of the ink outlet 65 of the ink bottle 63 is aligned with the central axis line of the ink inlet 53 of the ink storage container 41 to which the ink is replenished. Here, the user visually compares the color (second portion) used to color the container addition portion 67 of the ink bottle 63 held by hand with the color (first portion) used to color the periphery of the opening edge on the upper side of the through-hole 60 where the ink inlet 53 of the ink storage container 41 to which the ink is replenished is provided. Further, when the colors are the same as each other (in this case, black), it is confirmed that the ink bottle 63 suitable for the current ink replenishment is held by hand, the ink replenishment is carried out. That is, the ink is replenished from the ink bottle to the ink storage container.

As shown in FIG. 6, it is preferable that the ink bottle 63 be positioned above the ink inlet 53 of the ink storage container 41 by turning the ink bottle 63 upside down from the viewpoint of easily replenishing the ink. Further, the position of the ink bottle 63 during the replenishment of the ink is not limited to a position above the ink inlet 53, and the ink bottle 63 may be positioned obliquely above the ink inlet 53.

Further, as shown in FIG. 6, it is preferable that the ink be replenished in a state where the ink outlet 65 of the ink bottle 63 is in contact with the vicinity of the ink inlet 53 of the ink storage container 41 from the viewpoint that the ink is unlikely to be spilled. Further, since the position of the ink bottle 63 is fixed to the vicinity of the ink inlet 53 of the ink storage container 41, the container main body portion 64 of the ink bottle 63 is likely to be dent, and thus the ink is likely to be pushed out and replenished.

In these cases, since the ink is likely to be pushed out from the ink outlet 65 of the ink bottle 63, the ink is likely to be foamed, air bubbles are likely to be formed, and foreign matter is likely to be generated at the gas-liquid interface, which is preferable from the viewpoint of reducing formation of air bubbles and foreign matter according to the present embodiment.

In FIG. 2 and the like, the ink inlet 53 may be covered with a lid, a cap, or the like (not shown) when the ink is not replenished. That is, the ink inlet 53 may be configured to be opened or closed with a lid or a cap.

According to the ink jet recording device described above, formation of air bubbles of the ink jet ink composition can be suppressed and generation of aggregates can also be suppressed by applying the above-described ink jet ink composition even when the ink jet recording device includes the ink storage container having an ink filling hole configured to be opened and closed. That is, in the ink storage container having an ink filling hole configured to be opened and closed, even when the ink filling hole is opened and closed by the user or the like and thus the ink jet ink composition is in a state of being easily dried, foaming and aggregation of the coloring material can be suppressed by an interaction between the water-soluble resin and the betaine, and an image with satisfactory color developability can be formed.

Further, since formation of air bubbles can be suppressed even when the ink jet ink composition is more likely to be foamed, for example, in a case where the ink storage container has a height of 3 cm or greater from the ink filling hole to the inner bottom, it can be said that the ink jet ink composition according to the present embodiment exhibits even more remarkable effects in such a case.

The height of the ink storage container from the ink filling hole to the inner bottom is, for example, preferably 1 cm or greater and 20 cm or less, more preferably in a range of 2 to 15 cm, and still more preferably in a range of 3 to 10 cm. When the height thereof from the ink filling hole to the inner bottom is greater than or equal to the above-described ranges, the ink capacity can be increased, which is preferable. When the height thereof from the ink filling hole to the inner bottom is less than or equal to the above-described ranges, foaming of the ink can be reduced, which is preferable. The height of the ink storage container from the ink filling hole to the inner bottom is, for example, the height from the bottom end of the ink inlet 53 (ink filling hole) in the downward direction to the bottom of the inner surface of the ink storage chamber 49 in FIG. 4.

### 1.7. Production and Physical Properties

The ink jet ink composition according to the present embodiment can be obtained by mixing the above-described components in any order, filtering the mixture as necessary, and removing impurities. As a mixing method, a method of sequentially adding materials to a container provided with a stirrer such as a mechanical stirrer or a magnetic stirrer and stirring and mixing the materials is suitably used. For example, centrifugal filtration or filter filtration can be performed as necessary as a filtration method.

From the viewpoint of the reliability of an ink jet ink, the surface tension of the ink jet ink composition according to the present embodiment at 20° C. is preferably 20 mN/m or greater and 40 mN/m or less and more preferably 22 mN/m or greater and 35 mN/m or less. Further, from the same viewpoint as described above, the viscosity of the ink at 20° C. is preferably 1.5 mPa-s or greater and 10 mPa-s or less and more preferably 2 mPa-s or greater and 8 mPa-s or less. The surface tension and the viscosity of the ink may be set to be in the above-described ranges by a method of adjusting the kinds of the water-soluble resin, the organic solvent, and the surfactant described above, the amounts of these components and water to be added, and the like.

### 2. Recording Method

A recording method according to the present embodiment is performed by using the ink jet recording device that includes the ink storage container having an ink filling hole as described above. Further, the recording method includes a step of jetting the above-described ink jet ink composition from an ink jet head of the ink jet recording device to make the ink jet ink composition adhere to a recording medium.

According to the ink jet recording method, the ink jet ink composition contains a self-dispersing pigment, a water-soluble resin, and a betaine, and when the content of the self-dispersing pigment is 3.5% by mass or greater and 8.5% by mass or less with respect to the total mass of the ink composition, the mass ratio (self-dispersing pigment/water-soluble resin) of the self-dispersing pigment to the water-soluble resin is 2.8 or greater and less than 30, and the content of the betaine is 2.5% by mass or greater and 9.5% by mass or less with respect to the total mass of the ink composition, foaming of the ink jet ink composition and generation of foreign matter are suppressed, and an image having satisfactory color developability and satisfactory rub fastness can be formed.

The recording medium is not particularly limited, and the recording medium may or may not have a recording surface that adsorbs a liquid. Therefore, the recording medium is not particularly limited, and for example, paper, a film, cloth, a metal, glass, or a polymer can be used. Further, transfer paper for performing sublimation transfer to a recording medium can also be used as the recording medium.

A liquid-absorbing recording medium is more preferable as the recording medium on which recording is performed by the recording method according to the present embodiment. The liquid-absorbing recording medium denotes “recording medium in which the water absorption amount from the start of contact to 30 msec^{1/2} in the Bristow method is greater than 10 mL/m²”. The Bristow method is a method that has been most widely used as a method of measuring the liquid absorption amount in a short time and that is also adopted by Japan Technical Association of The Pulp And Paper Industry (JAPAN TAPPI). The details of the recording method are described in Standard No. 51 “Paper and Paperboard, Liquid Absorbency Test Method, Bristow Method” of “Paper and Pulp Test Method (2000) by JAPAN TAPPI”.

As the liquid-absorbing recording medium, a recording medium having liquid absorbency due to a receiving layer provided to absorb a liquid on the surface of the recording medium may be used. Examples thereof include ink jet paper (paper exclusively for ink jet). Examples of the receiving layer that absorbs a liquid include a layer formed of a liquid-absorbing resin, liquid-absorbing inorganic fine particles, or the like.

Examples of the liquid-absorbing recording medium include a recording medium in which the base material of the recording medium has liquid absorbency. Examples thereof include fabrics formed of fibers and paper containing pulp as a component. Examples of the paper include plain paper, cardboard, and liner paper. Examples of the liner paper include paper formed of kraft pulp or used paper.

The step of making the ink jet ink composition adhere to the recording medium can be performed by using the above-described ink jet recording device. That is, the step of making the ink jet ink composition adhere to the recording medium can be performed by filling the ink jet head with the ink jet ink composition such that the ink jet ink composition can be jetted from a predetermined nozzle and jetting the ink jet ink composition to the recording medium at a predetermined timing in the above-described state.

Further, the recording method according to the present embodiment may include a step of heating the recording medium as appropriate. The step of heating the recording medium can be performed by, for example, using the above-described drying method or the like when the ink jet recording device is used. Further, the recording medium can be heated by an appropriate drying method without limiting to the ink jet recording device. In this manner, an image to be obtained can be dried, bleeding of the image can be suppressed, and the image can be more efficiently fixed. In addition, the recording method may include a step of replenishing the ink to the ink storage container.

Further, other steps can be added to the recording method according to the present embodiment as appropriate, and the recording method may include, for example, a step of applying other compositions and a washing step. According to the recording method of the present embodiment, since the above-described ink jet ink composition is used, foaming of the ink jet ink composition and generation of foreign matter can be suppressed, and an image with a satisfactory image quality and satisfactory fastness can be formed.

### 3. Set

A set according to the present embodiment includes the ink jet recording device that includes the ink storage container having the ink filling hole as described above and the ink jet ink composition that is used for performing recording by the ink jet recording device. In addition, the ink jet ink composition is the ink jet ink composition described above.

### 4. Examples and Comparative Examples

Hereinafter, the present disclosure will be described in detail based on examples, but the present disclosure is not limited to these examples. Hereinafter, “parts” and “%” are on a mass basis unless otherwise specified. Further, the evaluation was performed under conditions of a temperature of 25.0° C. and a relative humidity of 40.0% unless otherwise specified.

### 4.1. Preparation of Ink Jet Ink Composition

Ink jet ink compositions of the examples and the comparative examples were obtained by adding respective components to a container to have the compositions listed in Tables 1 to 4, mixing and stirring the mixtures with a magnetic stirrer for 2 hours, and filtering the mixtures with a membrane filter having a pore size of 5 μm.

The materials listed in Tables 1 to 4 are as follows.

A self-dispersing pigment was produced in the following manner.

20.0 g of a pigment, 11.0 mmol of monosodium salt of ((4-aminobenzoylamino)-methane-1,1-diyl)bisphosphate, 20.0 mmol of nitric acid, and 200 mL of pure water were mixed with each other.

Carbon black (trade name “BLACK PEARLS 880”, manufactured by Cabot Corporation) was used as the pigment. Further, the mixture was mixed at 6,000 rpm using a Silverson mixer at room temperature. After 30 minutes, 20.0 mmol of sodium nitrite dissolved in a small amount of water was slowly added to this mixture.

The temperature of the mixture reached 60° C. by adding sodium nitrite. The mixture was allowed to react in this state for 1 hour. Thereafter, the mixture was washed with water, and the pH of the mixture was adjusted to 10 by using a sodium hydroxide aqueous solution.

The obtained pigment was a self-dispersing pigment in which a —C₆H₄—CONH—CH—(PO(OH)(ONa))(PO(OH)₂) group was bonded to the surfaces of particles of the pigment.

### A Resin Dispersing Pigment was Produced in the Following Manner.

20 parts by mass of an organic solvent (methyl ethyl ketone), 0.03 parts by mass of a polymerization chain transfer agent (2-mercaptoethanol), 15 parts by mass of polypropylene glycol monomethacrylate (propylene oxide group=9), 15 parts by mass of poly(ethylene glycol/propylene glycol) monomethacrylate (propylene oxide group=7, ethylene oxide group=5), 12 parts by mass of methacrylic acid, 50 parts by mass of a styrene monomer, 10 parts by mass of a styrene macromer, and 10 parts by mass of benzyl methacrylate were added to a reaction container sufficiently subjected to nitrogen gas substitution, the mixture was stirred at 75° C., and 0.9 parts by mass of 2,2′-azobis(2,4-dimethylvaleronitrile) serving as a polymerization initiator which was dissolved in 40 parts by mass of methyl ethyl ketone with respect to 100 parts by mass of monomer components was added to the mixture for polymerization, thereby obtaining a polymer solution aged at 80° C. for 1 hour.

7.5 parts by mass of the water-soluble polymer obtained above was dissolved in 45 parts by mass of methyl ethyl ketone, a predetermined amount of a 20% sodium hydroxide aqueous solution (neutralizing agent) was added to the solution to neutralize a salt-forming group, 20 parts by mass of carbon black (trade name “BLACK PEARLS 880”, manufactured by Cabot Corporation) was further added to the solution as a pigment, and the solution was kneaded using a bead mill for 2 hours. 120 parts by mass of ion exchange water was added to the kneaded material obtained in the above-described manner, the solution was stirred, methyl ethyl ketone was removed at 6° C. under reduced pressure, and a part of water was further removed from the solution, thereby obtaining a resin-coated pigment dispersion liquid having a solid content concentration of 20% by mass.

A dispersion resin 1 was produced as resin particles in the following manner.

A reaction container provided with a stirrer, a reflux condenser, a dropping device, and a thermometer was charged with 900 g of ion exchange water and 1 g of sodium lauryl sulfate, and the temperature of the solution was heated to 70° C. while the reaction container was subjected to nitrogen substitution and the solution was stirred. The internal temperature was maintained at 70° C., 4 g of potassium persulfate was added to the solution as a polymerization initiator, and after the dissolution of the potassium persulfate, an emulsion prepared by adding 20 g of acrylamide, 365 g of styrene, 545 g of butyl acrylate, and 30 g of methacrylic acid to 450 g of ion exchange water and 3 g of sodium lauryl sulfate in advance while the solution was stirred was continuously added dropwise to the reaction container over 4 hours. After completion of the dropwise addition, the solution was aged for 3 hours. The obtained resin emulsion was cooled to room temperature, and ion exchange water and a sodium hydroxide aqueous solution were added to the emulsion to adjust the solid content to 40% by mass and the pH to 8. The glass transition temperature of the resin particles in the obtained aqueous emulsion was −6° C.

### A Dispersion Resin 2 (Soap-Free Dispersion Resin) was Produced in the Following Manner.

100 parts by mass of ion exchange water was added to a reaction container provided with a dropping device, a thermometer, a water-cooled reflux condenser, and a stirrer, 0.2 parts by mass of ammonium persulfate serving as a polymerization initiator was added at 70° C. in a nitrogen atmosphere while the solution was stirred, a monomer solution to which 40 parts by mass of styrene, 34.6 parts by mass of methyl methacrylate, 10 parts by mass of lauryl methacrylate, and 15.4 parts by mass of acrylic acid were added was added dropwise to the reaction container so that the solution was allowed to react, and a shell polymer was polymerized and prepared. Thereafter, a mixed solution of 0.2 parts by mass of potassium persulfate, 73 parts by mass of styrene, and 27 parts by mass of n-butyl acrylate was added dropwise thereto so that the solution was polymerized and allowed to react while being stirred at 70° C., the solution was neutralized with sodium hydroxide to adjust the pH to be in a range of 8 to 8.5 and filtered through a filter having a pore size of 0.3 μm, thereby preparing a soap-free resin emulsion.

### A Water-Soluble Resin 1 was Produced in the Following Manner.

93.4 parts of butanol was added to a reaction container provided with a gas introduction pipe, a thermometer, a condenser, and a stirrer, and the reaction container was subjected to nitrogen gas substitution. The reaction container was heated to 110° C., and a mixture of 101.1 parts of styrene, 38.5 parts of acrylic acid, 60.0 parts of maleic acid, and 6 parts of a polymerization initiator (trade name “V-601”, manufactured by FUJIFILM Wako Pure Chemical Corporation) was added dropwise to the reaction container over 2 hours to cause a polymerization reaction. The mixture was allowed to react at 110° C. for 3 hours, 0.6 parts of a polymerization initiator was further added thereto, and the mixture was allowed to continuously react at 110° C. for 1 hour, thereby obtaining a solution of a resin. The mixture was cooled to room temperature, 37.1 parts of dimethylaminoethanol was added thereto to neutralize the mixture, and 100 parts of water was further added thereto. The mixture was heated to 100° C. or higher, an azeotrope was formed with water to distill off butanol, and the concentration thereof was adjusted. In this manner, a liquid containing a water-soluble resin 1 in which the content of the resin was 20.0% was obtained. The acid value of the water-soluble resin 1 was 440 mgKOH/g measured by a titration method, the proportion of the water-soluble monomer was 49% by mass, and the weight-average molecular weight was 12,000.

### A Water-Soluble Resin 2 was Produced in the Following Manner.

93.4 parts of butanol was added to a reaction container provided with a gas introduction pipe, a thermometer, a condenser, and a stirrer, and the reaction container was subjected to nitrogen gas substitution. The reaction container was heated to 110° C., and a mixture of 101.5 parts of styrene, 98.5 parts of acrylic acid, and 6 parts of a polymerization initiator (trade name “V-601”, manufactured by FUJIFILM Wako Pure Chemical Corporation) was added dropwise to the reaction container over 2 hours to cause a polymerization reaction. The mixture was allowed to react at 110° C. for 3 hours, 0.6 parts of a polymerization initiator was further added thereto, and the mixture was allowed to continuously react at 110° C. for 1 hour, thereby obtaining a solution of a resin. The mixture was cooled to room temperature, 37.1 parts of dimethylaminoethanol was added thereto to neutralize the mixture, and 100 parts of water was further added thereto. The mixture was heated to 100° C. or higher, an azeotrope was formed with water to distill off butanol, and the concentration thereof was adjusted. In this manner, a liquid containing a water-soluble resin 2 in which the content of the water-soluble resin 2 was 20.0% was obtained. The acid value of the water-soluble resin 2 was 383 mgKOH/g measured by a titration method, the proportion of the water-soluble monomer was 49% by mass, and the weight-average molecular weight was 12,000.

### A Water-Soluble Resin 3 (60% or Greater of a Water-Soluble Monomer) was Produced in the Following Manner.

93.4 parts of butanol was added to a reaction container provided with a gas introduction pipe, a thermometer, a condenser, and a stirrer, and the reaction container was subjected to nitrogen gas substitution. The reaction container was heated to 110° C., and a mixture of 101.5 parts of styrene, 38.5 parts of acrylic acid, 210.0 parts of maleic acid, and 6 parts of a polymerization initiator (trade name “V-601”, manufactured by FUJIFILM Wako Pure Chemical Corporation) was added dropwise to the reaction container over 2 hours to cause a polymerization reaction. The mixture was allowed to react at 110° C. for 3 hours, 0.6 parts of a polymerization initiator was further added thereto, and the mixture was allowed to continuously react at 110° C. for 1 hour, thereby obtaining a solution of a resin. The mixture was cooled to room temperature, 37.1 parts of dimethylaminoethanol was added thereto to neutralize the mixture, and 100 parts of water was further added thereto. The mixture was heated to 100° C. or higher, an azeotrope was formed with water to distill off butanol, and the concentration thereof was adjusted. In this manner, a liquid containing a water-soluble resin 3 in which the content of the water-soluble resin 3 was 20.0% was obtained. The acid value of the water-soluble resin 3 was 664 mgKOH/g measured by a titration method, the proportion of the water-soluble monomer was 71% by mass, and the weight-average molecular weight was 12,000.

A Water-Soluble Resin 4 (Less than 60% of a Water-Soluble Monomer) was Produced in the Following Manner.

93.4 parts of butanol was added to a reaction container provided with a gas introduction pipe, a thermometer, a condenser, and a stirrer, and the reaction container was subjected to nitrogen gas substitution. The reaction container was heated to 110° C., and a mixture of 150.0 parts of styrene, 25.0 parts of acrylic acid, 30.0 parts of maleic acid, and 6 parts of a polymerization initiator (trade name “V-601”, manufactured by FUJIFILM Wako Pure Chemical Corporation) was added dropwise to the reaction container over 2 hours to cause a polymerization reaction. The mixture was allowed to react at 110° C. for 3 hours, 0.6 parts of a polymerization initiator was further added thereto, and the mixture was allowed to continuously react at 110° C. for 1 hour, thereby obtaining a solution of a resin. The mixture was cooled to room temperature, 37.1 parts of dimethylaminoethanol was added thereto to neutralize the mixture, and 100 parts of water was further added thereto. The mixture was heated to 100° C. or higher, an azeotrope was formed with water to distill off butanol, and the concentration thereof was adjusted. In this manner, a liquid containing a water-soluble resin 4 in which the content of the water-soluble resin 4 was 20.0% was obtained. The acid value of the water-soluble resin 4 was 236 mgKOH/g measured by a titration method, the proportion of the water-soluble monomer was 27% by mass, and the weight-average molecular weight was 12,000.
OLFINE E1010: manufactured by Nissin Chemical Co., Ltd., acetylene glycol-based surfactant
OLFINE EXP4300: manufactured by Nissin Chemical Co., Ltd., acetylene glycol-based surfactant
OLFINE D-10PG: manufactured by Nissin Chemical Co., Ltd., acetylene glycol-based surfactant

### 4.2. Evaluation Method

### 4.2.1. Recording Test

EW-873T (manufactured by Seiko Epson Corporation) was modified and prepared by installing an ink storage container having an ink filling hole. Devices having heights from the inner bottom of the ink storage container to the ink filling hole were set to 2 cm, 3 cm, and 5 cm were respectively prepared. XeroxP (manufactured by Fuji Xerox Co., Ltd.) was used as a recording medium used for performing recording of a recording test. A monochrome 100% Duty pattern 101 was recorded by setting the adhesion amount of the ink to the recording medium to 4 mg/inch².

4.2.2. LM Property Immediately after Printing (Line Marker Test Immediately after Recording)

An image immediately after being recorded was rubbed with a line marker once or twice, and the visually observed results were evaluated according to the following evaluation criteria. The evaluation results are listed in Tables 5 to 8. Since the test was performed on the image immediately after printing, the rank of B or higher is desirable and the rank of A or higher is more desirable.
A: The mark was not noticeable even when the image was rubbed twice.
B: The mark was not noticeable when the image was rubbed once.
C: The mark was noticeable when the image was rubbed once.
   4.2.3. LM Property after 5 Minutes from Printing (Line Marker Test 5 Minutes after Recording)

An image allowed to remain for 5 minutes after being recorded was rubbed with a line marker once or twice, and the visually observed results were evaluated according to the following evaluation criteria. The evaluation results are listed in Tables 5 to 8. Since the test was performed on the image allowed to remain for 5 minutes after being printed, the rank of A or higher is desirable.
A: The mark was not noticeable even when the image was rubbed twice.
B: The mark was not noticeable when the image was rubbed once.
C: The mark was noticeable when the image was rubbed once.

### 4.2.4. Clogging Resistance

The ink storage container of the recording device were respectively filled with the ink of each example. The printing was performed for one hour a day, the printer was stopped when the printing was not performed, and this process was repeatedly performed for one month. During this period, the ink was replenished when the amount of the ink in the ink storage containers reached the lower limit. The nozzles were inspected after one month and evaluated according to the following evaluation criteria. The evaluation results are listed in Tables 5 to 8. The rank of B or higher is desirable.
A: The percentage of nozzles with jetting failure was 1% or less.
B: The percentage of nozzles with jetting failure was greater than 1% and 3% or less.
C: The percentage of nozzles with jetting failure was greater than 3%.

Further, in the example with the evaluation result of “C”, foreign matter was generated at the ink-liquid surface (gas-liquid interface) inside the ink storage container.

In addition, the above-described recording device was modified to a similar recording device except that the ink storage container was not provided and the ink was supplied from a cartridge, which had been filled with the ink, directly to the ink jet head, and the evaluation was performed in the same manner using the modified recording device. As a result, all examples were evaluated as B or higher.

### 4.2.5. Defoaming Properties

A 110 ml screw pipe bottle was charged with 20 g of the ink of each example and sealed with a stopper. The screw pipe bottle containing the ink was shaken at about 10 times/5 sec with an amplitude of 10 cm. Thereafter, the defoaming state was evaluated by determining whether bubbles disappeared to the extent that the liquid level was visible based on the following evaluation criteria. The evaluation results are listed in Tables 5 to 8. The rank of B or higher is desirable.
A: The liquid level was visible within 1 minute.
B: The liquid level was visible within 5 minutes.
C: The liquid level was not visible even after 5 minutes.

### 4.2.6. Optical Density (OD Value)

The monochrome 100% Duty pattern 101 was measured by a colorimeter. The evaluation was performed according to the following evaluation criteria based on the obtained OD values. The evaluation results are listed in Tables 5 to 8. The rank of B or higher is desirable.
A: The OD value was 1.1 or greater.
B: The OD value was 0.9 or greater and less than 1.1.
C: The OD value was less than 0.9.

### 4.2.7. Evaluation of Foaming Inside Container

Containers with different heights of 2 cm, 3 cm, and 5 cm from the inner bottom of the ink storage container to the ink filling hole were filled with 40 g of the ink of each example from the ink filling hole. The height of foaming after one minute from the filling was evaluated according to the following evaluation criteria. The evaluation results are listed in Tables 5 to 8. The rank of A is desirable.
A: The height of foaming after one minute was 2 mm or less.
B: The height of foaming after one minute was greater than 2 mm.

### 4.2.8. Evaluation of Countermeasure for Microplastics

It was determined whether the ink contained water-insoluble resins. The results are listed in Tables 1 to 4. The rank of A is desirable.
A: The ink contained no water-insoluble resins.
B: The ink contained water-insoluble resins.

### 4.3. Evaluation Results

As listed in Tables 5 to 8, it was found that the ink jet ink composition of each example, containing a self-dispersing pigment, a water-soluble resin, and a betaine, in which the content of the self-dispersing pigment was 3.5% by mass or greater and 8.5% by mass or less with respect to a total mass of the ink composition, the mass ratio (self-dispersing pigment/water-soluble resin) of the self-dispersing pigment to the water-soluble resin was 2.8 or greater and less than 30, and the content of the betaine was 2.5% by mass or greater and 9.5% by mass or less with respect to the total mass of the ink composition, had satisfactory clogging resistance, fastness (rub resistance), and color developability.

The present disclosure has configurations that are substantially the same as the configurations described in the embodiments, for example, configurations with the same functions, the same methods, and the same results as described above or configurations with the same purposes and the same effects as described above. Further, the present disclosure has configurations in which parts that are not essential in the configurations described in the embodiments have been substituted. Further, the present disclosure has configurations exhibiting the same effects as the effects of the configurations described in the embodiments or configurations capable of achieving the same purposes as the purposes of the configurations described in the embodiments. Further, the present disclosure has configurations in which known techniques have been added to the configurations described in the embodiments.

The following contents are derived from the embodiments and the modified examples described above.

An ink jet ink composition is an aqueous ink jet ink composition including a self-dispersing pigment, a water-soluble resin, and a betaine, in which the ink composition is used for an ink jet recording device that includes an ink storage container having an ink filling hole, a content of the self-dispersing pigment is 3.5% by mass or greater and 8.5% by mass or less with respect to a total mass of the ink composition, a mass ratio (self-dispersing pigment/water-soluble resin) of the self-dispersing pigment to the water-soluble resin is 2.8 or greater and less than 30, and a content of the betaine is 2.5% by mass or greater and 9.5% by mass or less with respect to the total mass of the ink composition.

According to the ink jet ink composition, air bubbles and foreign matter are unlikely to be generated even when the ink jet ink composition is used by the ink jet recording device that includes an ink storage container having an ink filling hole, and thus an image with excellent fastness and excellent color developability can be formed. These effects are exhibited by the interaction of the specific formulation of the self-dispersing pigment, the water-soluble resin, and the betaine.

In the ink jet ink composition described above, a content of the water-soluble resin may be 0.3% by mass or greater and 2% by mass or less with respect to the total mass of the ink composition.

According to the ink jet ink composition, the fixing properties of the image are more appropriate, and the viscosity is further enhanced.

In the ink jet ink composition described above, the ink storage container may have a height of 3 cm or greater from the ink filling hole to an inner bottom thereof.

According to the ink jet ink composition, air bubbles are unlikely to be generated even in a state where air bubbles are more likely to be generated, and thus more remarkable effects can be obtained.

In the ink jet ink composition described above, a content of a resin particle may be less than 0.1% by mass with respect to the total mass of the ink composition.

According to the ink jet ink composition, generation of foreign matter is further suppressed.

In the ink jet ink composition described above, the water-soluble resin may be selected from an acrylic resin or a maleic acid-based resin.

According to the ink jet ink composition, the image quality of the image to be obtained can be further enhanced.

In the ink jet ink composition described above, a proportion of a water-soluble monomer in the water-soluble resin may be less than 60% by mass when an amount of all monomers in the water-soluble resin is set to 100% by mass.

According to the ink jet ink composition, clogging can be further reduced, and the water solubility can be more sufficiently obtained.

In the ink jet ink composition described above, the betaine may be selected from trialkylglycine.

According to the ink jet ink composition, aggregation of the water-soluble resin is unlikely to occur.

In the ink jet ink composition described above, the water-soluble resin may have an acid value.

According to the ink jet ink composition, the fastness of the image can be further enhanced.

In the ink jet ink composition described above, the ink composition may be used for performing recording on an absorbing recording medium.

In the ink jet ink composition described above, the ink jet ink composition may further contain polyols having a standard boiling point of higher than 280° C.

According to the ink jet ink composition, clogging is more likely to be suppressed.

A recording method performed by using an ink jet recording device that includes an ink storage container having an ink filling hole, the method including a step of jetting an ink jet ink composition from an ink jet head of the ink jet recording device to make the ink jet ink composition adhere to a recording medium, in which the ink jet ink composition is the ink jet ink composition described above.

According to the recording method, air bubbles and foreign matter are unlikely to be generated even when the ink jet ink composition is used by the ink jet recording device that includes an ink storage container having an ink filling hole, and thus an image with excellent fastness and excellent color developability can be formed. These effects are exhibited by the interaction of the specific formulation of the self-dispersing pigment, the water-soluble resin, and the betaine.

A set including an ink jet recording device that includes an ink storage container having an ink filling hole, and an ink jet ink composition that is used for performing recording by the ink jet recording device, in which the ink jet ink composition is the ink jet ink composition described above.

According to the set, air bubbles and foreign matter are unlikely to be generated even when the ink jet ink composition is used by the ink jet recording device that includes an ink storage container having an ink filling hole, and thus an image with excellent fastness and excellent color developability can be formed. These effects are exhibited by the interaction of the specific formulation of the self-dispersing pigment, the water-soluble resin, and the betaine.

What is claimed is:

1. An aqueous ink jet ink composition comprising:
a self-dispersing pigment;
a water-soluble resin; and
a betaine,
wherein the ink jet ink composition is used by an ink jet recording device that includes an ink storage container having an ink filling hole,
a content of the self-dispersing pigment is 3.5% by mass or greater and 8.5% by mass or less with respect to a total mass of the ink composition,
a mass ratio (self-dispersing pigment/water-soluble resin) of the self-dispersing pigment to the water-soluble resin is 2.8 or greater and less than 30, and
a content of the betaine is 2.5% by mass or greater and 9.5% by mass or less with respect to the total mass of the ink composition.

2. The ink jet ink composition according to claim 1,
wherein a content of the water-soluble resin is 0.3% by mass or greater and 2% by mass or less with respect to the total mass of the ink composition.

3. The ink jet ink composition according to claim 1,
wherein the ink storage container has a height of 3 cm or greater from the ink filling hole to an inner bottom thereof.

4. The ink jet ink composition according to claim 1,
wherein a content of a resin particle is less than 0.1% by mass with respect to the total mass of the ink composition.

5. The ink jet ink composition according to claim 1,
wherein the water-soluble resin is selected from an acrylic resin or a maleic acid-based resin.

6. The ink jet ink composition according to claim 1,
wherein a proportion of a water-soluble monomer in the water-soluble resin is less than 60% by mass when an amount of all monomers in the water-soluble resin is set to 100% by mass.

7. The ink jet ink composition according to claim 1,
wherein the betaine is selected from trialkylglycine.

8. The ink jet ink composition according to claim 1,
wherein the water-soluble resin has an acid value.

9. The ink jet ink composition according to claim 1,
wherein the ink composition is used for performing recording on an absorbing recording medium.

10. The ink jet ink composition according to claim 1, further comprising:
polyols having a standard boiling point of higher than 280° C.

11. A recording method performed by using an ink jet recording device that includes an ink storage container having an ink filling hole, the method comprising:
jetting an ink jet ink composition from an ink jet head of the ink jet recording device to make the ink jet ink composition adhere to a recording medium,
wherein the ink jet ink composition is the ink jet ink composition according to claim 1.

12. A set comprising:
an ink jet recording device that includes an ink storage container having an ink filling hole; and
an ink jet ink composition that is used for performing recording by the ink jet recording device,
wherein the ink jet ink composition is the ink jet ink composition according to claim 1.
